(19) United States
(12) Patent Application Publication
(10) Pub. No.: US 2022/0332953 A1
(43) Pub. Date: Oct. 20, 2022

(54) COMPOSITION, FILM, CURED FILM, MANUFACTURING METHOD OF CURED FILM, AND ELECTRONIC COMPONENT

(71) Applicant: FUJIFILM Corporation, Tokyo (JP)

(72) Inventor: Tatsuo ISHIKAWA, Haibara-gun (JP)

(73) Assignee: FUJIFILM Corporation, Tokyo (JP)

(21) Appl. No.: 17/848,982

(22) Filed: Jun. 24, 2022

Related U.S. Application Data
(63) Continuation of application No. PCT/JP2020/046700, filed on Dec. 15, 2020.

(30) Foreign Application Priority Data
Dec. 26, 2019 (JP) 2019-236796

(51) Int. Cl. C09D 5/00; C08K 3/08; C08K 3/22; C09D 7/65

(52) U.S. Cl. CPC C09D 5/006; C08K 3/08; C08K 3/22; C09D 7/65; C08K 2003/0843; C08K 2003/0856; C08K 2003/2227; C08K 2003/2265

(57) ABSTRACT

A first object of the present invention is to provide a composition that contains electromagnetic wave absorbing particles and has excellent dispersion stability. A second object of the present invention is to provide a film and a cured film that are formed using the aforementioned composition and a manufacturing method of a cured film. A third object of the present invention is to provide an electronic component including a cured film formed using the aforementioned composition.

The composition according to an aspect of the present invention contains electromagnetic wave absorbing particles, a dispersant, and a solvent.

The composition absorbs electromagnetic waves in a frequency band of 1 GHz or higher when formed into a film.

### CROSS-REFERENCE TO RELATED APPLICATIONS

This application is a Continuation of PCT International Application No. PCT/JP2020/046700 filed on Dec. 15, 2020, which claims priority under 35 U.S.C. § 119(a) to Japanese Patent Application No. 2019-236796 filed on Dec. 26, 2019. The above application is hereby expressly incorporated by reference, in its entirety, into the present application.

### BACKGROUND OF THE INVENTION

### 1. Field of the Invention

The present invention relates to a composition, a film, a cured film, a manufacturing method of a cured film, and an electronic component.

### 2. Description of the Related Art

In recent years, the frequency used in electronic communication devices and the like has been rapidly raised. For example, for communication devices such as mobile phones, a high frequency band of 1 GHz or higher is being used. Accordingly, electronic components (for example, an inductor, an antenna, and the like) included in these devices are also required to function well for higher frequencies.

Therefore, currently, many electromagnetic wave absorbing materials having absorption performance in a high frequency band are being studied. For example, JP2009-224414A discloses an electromagnetic wave absorbing material that has a peak of absorption amount of electromagnetic waves in a frequency band higher than 120 GHz.

### SUMMARY OF THE INVENTION

In order to obtain a film that can absorb electromagnetic waves in a high frequency band of 1 GHz or higher, the inventors of the present invention prepared and studied a composition containing electromagnetic wave absorbing particles and a solvent. As a result, the inventors have revealed that in a case where the composition containing electromagnetic wave absorbing particles and a solvent is stored for a long period of time, the composition is likely to experience change in viscosity. That is, it has been revealed that there is a room for further improving dispersion stability of the composition.

An object of an aspect of the present invention is to provide a composition that contains electromagnetic wave absorbing particles and has excellent dispersion stability.

Another object of the aspect of the present invention is to provide a film and a cured film that are formed using the aforementioned composition and a manufacturing method of a cured film.

A still another object of the aspect of the present invention is to provide an electronic component that includes a cured film formed using the aforementioned composition.

Regarding the above objects, the inventors of the present invention conducted intensive studies. As a result, the inventors have found that the objects can be achieved by the following configuration, and accomplished the present invention.

[1] A composition containing electromagnetic wave absorbing particles, a dispersant, and a solvent,

in which the composition absorbs electromagnetic waves in a frequency band of 1 GHz or higher when formed into a film.

[2] The composition described in [1], in which the particles include magnetoplumbite-type hexagonal ferrite particles represented by the following Formula (1).

AFe₍₁₂₋ₓ₎AlₓO₁₉ Formula (1)

In Formula (1), A represents at least one kind of metal element selected from the group consisting of Sr, Ba, Ca, and Pb, and x satisfies 1.5≤x≤8.0.

[3] The composition described in [1], in which the particles include Fe—Co-based alloy particles.

[4] The composition described in any one of [1] to [3], in which the composition absorbs electromagnetic waves in a frequency band of 1 GHz or higher and lower than 100 GHz when formed into a film.

[5] The composition described in any one of [1] to [4], in which a molecular weight of the dispersant is 50,000 or less.

[6] The composition described in any one of [1] to [5], wherein the dispersant is a resin having a graft chain

[7] The composition described in any one of [1] to [6], in which a content of the particles is 60.0% to 95.0% by mass with respect to a total mass of the composition.

[8] The composition described in any one of [1] to [7], in which a content of the dispersant is 1.0% to 10.0% by mass with respect to a total mass of the composition.

[9] The composition described in any one of [1] to [8], in which a content of the solvent is 10.0% to 30.0% by mass with respect to a total mass of the composition.

[10] The composition described in any one of [1] to [9], in which a boiling point of the solvent is 110° C. to 170° C.

[11] The composition described in any one of [1] to [10], further containing a thermally polymerizable compound.

[12] The composition described in any one of [1] to [10], further containing a photopolymerizable compound.

[13] The composition described in [12], further containing a photopolymerization initiator.

[14] A film formed of the composition described in any one of [1] to [13].

[15] A cured film formed by curing the composition described in any one of [11] to [13].

[16] A manufacturing method of a cured film, including a step of forming a composition layer on a substrate by using the composition described in [13],

a step of exposing the composition layer in a patterned manner, and

a step of developing the exposed composition layer by using a developer.

[17] An electronic component including the cured film described in [15].

According to the present invention, it is possible to provide a composition that contains electromagnetic wave absorbing particles and has excellent dispersion stability.

Furthermore, according to the present invention, it is possible to provide a film and a cured film that are formed using the aforementioned composition and a manufacturing method of a cured film.

In addition, according to the present invention, it is possible to provide an electronic component that includes a cured film formed using the aforementioned composition.

### DESCRIPTION OF THE PREFERRED EMBODIMENTS

Hereinafter, the present invention will be specifically described.

The following constituents will be described based on typical embodiments of the present invention in some cases. However, the present invention is not limited to the embodiments.

Regarding the notation of a group (atomic group) in the present specification, unless the gist of the present invention is missed, the notation without the terms “substituted” and “unsubstituted” includes both the group having no substituent and the group having a substituent. For example, “alkyl group” includes not only an alkyl group having no substituent (unsubstituted alkyl group) but also an alkyl group having a substituent (substituted alkyl group). Furthermore, in the present specification, “organic group” refers to a group having at least one carbon atom.

In the present specification, “actinic ray” or “radiation” means, for example, a bright line spectrum of a mercury lamp, a far ultraviolet ray represented by an excimer laser, extreme ultraviolet (EUV light), an X-ray, an electron beam (EB), and the like. In the present specification, “light” means an actinic ray or radiation.

Unless otherwise specified, “exposure” in the present specification means not only the exposure performed using a bright line spectrum of a mercury lamp, a far ultraviolet ray represented by an excimer laser, extreme ultraviolet, an X-ray, EUV light, and the like, but also the drawing performed using particle beams such as an electron beam and an ion beam.

In the present specification, a range described using “to” includes the numerical values listed before and after “to” as a lower limit and an upper limit.

In the present specification, (meth)acrylate represents acrylate and methacrylate, (meth)acryl represents acryl and methacryl, and (meth)acryloyl represents acryloyl and methacryloyl.

In the present specification, a weight-average molecular weight (Mw) is a polystyrene-equivalent value obtained by a Gel Permeation Chromatography (GPC) method.

The GPC method in the present specification is based on a method using HLC-8020GPC (manufactured by Tosoh Corporation), columns consisting of TSKgel SuperHZM-H, TSKgel SuperHZ4000, and TSKgel SuperHZ2000 (manufactured by Tosoh Corporation, 4.6 mm ID×15 cm), and tetrahydrofuran (THF) as an eluent.

### Composition

The composition according to an aspect of the present invention contains electromagnetic wave absorbing particles, a dispersant, and a solvent, and absorbs electromagnetic waves in a frequency band of 1 GHz or higher when formed into a film.

Due to the above configuration, the composition according to the aspect of the present invention is excellent in dispersion stability of the electromagnetic wave absorbing particles. That is, this composition is unlikely to experience a change in viscosity even being stored for a long period of time.

The mechanism of action between the above configuration and effect is unclear, but is assumed to be as below.

Presumably, in the aforementioned composition, due to the existence of the dispersant, either or both of the aggregation of the electromagnetic wave absorbing particles and the aggregation of the electromagnetic wave absorbing particles and other components that can be optionally added are unlikely to occur, and the electromagnetic wave absorbing particles existing in the composition may have an average particle diameter that is close to an average primary particle diameter of the particles. Particularly, in a case where the dispersant is a resin having a graft chain as will be described later, the aggregation described above could be further suppressed. As a result, the composition is unlikely to experience a change in viscosity even being stored for a long period of time.

Hereinafter, first, each of the components contained in the composition according to the aspect of the present invention will be described.

### Specific Electromagnetic Wave Absorbing Particles

The composition according to the aspect of the present invention contains electromagnetic wave absorbing particles.

The material constituting the electromagnetic wave absorbing particles preferably contains a metal element. Particularly, the material preferably contains at least one kind of metal element selected from the group consisting of Fe, Ni, and Co, and more preferably contains an Fe element.

The form of the aforementioned metal element existing in the electromagnetic wave absorbing particles is not particularly limited, and examples thereof include an alloy, a metal oxide, a metal nitride, and a metal carbide. That is, for example, in a case where the electromagnetic wave absorbing particles contain an Fe element as a metal element, the Fe element may be contained in the electromagnetic wave absorbing particles in the form of an alloy with another metal element, an iron oxide, an iron nitride, an iron carbide, and the like.

The material constituting the electromagnetic wave absorbing particles may contain other elements different from Fe, Ni, and Co. Specific examples of those other elements include Al, Si, S, Sc, Ti, V, Cu, Y, Mo, Rh, Pd, Ag, Sn, Sb, Te, Ba, Ta, W, Re, Au, Bi, La, Ce, Pr, Nd, P, Zn, Sr, Zr, Mn, Cr, Nb, Pb, Ca, B, C, N, and the like.

The electromagnetic wave absorbing particles are particularly preferably magnetic particles.

Specific examples of the material constituting the electromagnetic wave absorbing particles include an Fe—Co-based alloy (preferably permendur), an Fe—Ni-based alloy (for example, permalloy), an Fe—Zr-based alloy, an Fe—Mn-based alloy, an Fe—Si based alloy, an Fe—Al based alloy, an Ni—Mo-based alloy (preferably supermalloy), an Fe—Ni—Co-based alloy, ab Fe—Si—Cr-based based alloy, an Fe—Si—B-based alloy, an Fe—Si—Al-based alloy (preferably sendust), an Fe—Si—B—C-based alloy, an Fe—Si—B—Cr-based alloy, an Fe—Si—B—Cr—C-based alloy, an Fe—Co—Si—B-based alloy, an Fe—Si—B—Nb-based alloy, an Fe nanocrystal alloy, an Fe group amorphous alloy, a Co group amorphous alloy, a spinel ferrite (preferably an Ni—Zn-based ferrite or an Mn—Zn-based ferrite), and a hexagonal ferrite (preferably barium ferrite or a magnetoplumbite-type hexagonal ferrite represented by Formula (F1) which will be described later (hereinafter, also called “electromagnetic wave absorbing particles (F1)”). The above alloys may be amorphous.

Among these, in view of forming a film having higher electromagnetic wave absorption performance, alloy particles containing an Fe element are preferable, an Fe—Co-based alloy or a hexagonal ferrite is more preferable, and an Fe—Co-based alloy or electromagnetic wave absorbing particles (F1) are more preferable.

As the material constituting the electromagnetic wave absorbing particles, one kind of material may be used alone, or two or more kinds of materials may be used in combination.

The particle diameter of the electromagnetic wave absorbing particles is not particularly limited. However, in a case where the electromagnetic wave absorbing particles are particles other than the electromagnetic wave absorbing particles (F1) which will be described later, in view of forming a film having higher electromagnetic wave absorption performance, the average primary particle diameter of the electromagnetic wave absorbing particles is preferably 150 nm or less, more preferably 50 nm or less, and even more preferably 40 nm or less. The lower limit of the particle diameter is not particularly limited, and is, for example, 1 nm or more, preferably 10 nm or more, and more preferably 20 nm or more.

The particle diameter of primary particles of the electromagnetic wave absorbing particles can be measured by imaging the electromagnetic wave absorbing particles by using a transmission electron microscope at 100,000× photographing magnification, printing the image on printing paper at total magnification of 500,000× so as to obtain an image of the particles, tracing the contour of the particles (primary particles) with a digitizer, and calculating the diameter of circles having the same area as the area of the traced regions (equivalent circular area diameter). Here, the primary particles refer to independent particles not being aggregated. The imaging using a transmission electron microscope is performed by a direct method by using a transmission electron microscope at an acceleration voltage of 300 kV. The observation and measurement with the transmission electron microscope can be performed using, for example, a transmission electron microscope H-9000 manufactured by Hitachi, Ltd. and image analysis software KS-400 manufactured by Carl Zeiss AG.

Regarding the shape of the electromagnetic wave absorbing particles, “flat” means a shape having two opposing flat surfaces. On the other hand, among the particle shapes that do not have such flat surfaces, a shape having a difference between the major axis and the minor axis is “elliptical”. The axis (straight line) along which the maximum length of a particle can be taken is determined as the major axis. In contrast, the axis along which the length of a straight line in the particle orthogonal to the major axis is maximized is determined as the minor axis. A shape having no difference between the major axis and the minor axis, that is, a shape satisfying major axis length =minor axis length is “spherical”. A shape from which the major axis and the minor axis cannot be specified is called “amorphous”. In a case where the transmission electron microscope is used to specify the aforementioned particle shapes, the particles to be imaged are not subjected to an alignment treatment. The electromagnetic wave absorbing particles may have any of flat, elliptical, spherical, and amorphous shapes.

In a case where commercially available products are used, the catalog values are adopted as the average primary particle diameter of various particles described in the present specification.

In a case where there is no catalog value, the arithmetic mean of diameters of 500 particles randomly extracted from the image of the particles captured as described above is used.

As the electromagnetic wave absorbing particles in the composition according to the aspect of the present invention, a plurality of particles having different average primary particle diameters may be used in combination.

In contrast, in a case where the electromagnetic wave absorbing particles are the electromagnetic wave absorbing particles (F1) which will be described later, in view of forming a film having higher electromagnetic wave absorption performance, the number-average particle diameter D50 thereof is preferably 2 to 100 μm. The number-average particle diameter D50 means that particles having a diameter smaller than D50 account for 50% by number in a number-based particle size distribution.

The number-average particle diameter D50 can be measured, for example, using a particle size distribution analyzer. As a measurement device, for example, a laser diffraction/scattering type particle size distribution analyzer LA-960 (model number) manufactured by HORIBA, Ltd. can be used. However, the measurement device is not limited to this.

The electromagnetic wave absorbing particles (F1) are as follows.

AFe₍₁₂₋ₓ₎AlₓO₁₉ Formula (1)

In Formula (F1), A represents at least one kind of metal element selected from the group consisting of Sr, Ba, Ca, and Pb, and x satisfies 1.5≤x≤8.0.

In Formula (F1), as long as A is at least one kind of metal element selected from the group consisting of Sr, Ba, Ca, and Pb, the type and number of metal elements are not particularly limited.

In view of better operability and better handleability, A is preferably at least one kind of metal element selected from the group consisting of Sr, Ba, and Ca.

In Formula (F1), x satisfies 1.5≤x≤8.0, preferably satisfies 1.5≤x≤6.0, and more preferably satisfies 2.0≤x≤6.0.

In a case where x in Formula (F1) is 1.5 or more, the electromagnetic wave absorbing particles (F1) can absorb electromagnetic waves in a frequency band higher than 60 GHz.

In a case where x in Formula (F1) is 8.0 or less, the electromagnetic wave absorbing particles (F1) have magnetism.

Specific examples of the electromagnetic wave absorbing particles (F1) include SrFe_{(9.58)}Al_{(2.42)}O₁₉, SrFe_{(9.37)}Al_{(2.63)}O₁₉, SrFe_{(9.27)}Al_{(2.73)}O₁₉, SrFe_{(9.85)}Al_{(2.15)}O₁₉, SrFe_{(10.00)}Al_{(2.00)}O₁₉, SrFe_{(9.74)}Al_{(2.26)}O₁₉, SrFe_{(10.44)}Al_{(1.56)}O₁₉, SrFe_{(9.79)}Al_{(2.21)}O₁₉, SrFe_{(9.33)}Al_{(2.67)}O₁₉, SrFe_{(7.88)}Al_{(4.12)}O₁₉, SrFe_{(7.04)}Al_{(4.96)}O₁₉, SrFe_{(7.37)}Al_{(4.63)}O₁₉, SrFe_{(6.25)}Al_{(5.75)}O₁₉, SrFe_{(7.71)}Al_{(4.29)}O₁₉, SrFe_{(0.80)}Ba_{(0.10)}Ca_{(0.10)}Fe_{(9.83)}Al_{(2.17)}O₁₉, BaFe_{(9.50)}Al_{(2.50)}O₁₉, CaFe_{(10.00)}Al_{(2.00)}O₁₉, PbFe_{(9.00)}Al_{(3.00)}O₁₉, and the like.

The makeup of the electromagnetic wave absorbing particles (F1) can be confirmed by high-frequency inductively coupled plasma (ICP) emission spectroscopy.

Specifically, a pressure-resistant container containing 12 mg of sample particles and 10 mL of a 4 mol/L (liter, the same shall be applied hereinafter) aqueous hydrochloric acid solution is kept in an oven at a set temperature of 120° C. for 12 hours, thereby obtaining a solution. Then, 30 mL of pure water is added to the obtained solution, and the solution is filtered using a 0.1 μm membrane filter. For the filtrate obtained in this way, elemental analysis is performed using a high-frequency inductively coupled plasma (ICP) emission spectrophotometer. Based on the obtained results of the elemental analysis, the content of each metal atom with respect to 100 at % of iron atoms is determined. Based on the obtained content, the makeup is confirmed.

Examples of the measurement device include a high-frequency inductively coupled plasma (ICP) emission spectrophotometer (model number: ICPS-8100) manufactured by Shimadzu Corporation.

It is preferable that the electromagnetic wave absorbing particles (F1) have a single-phase magnetoplumbite-type hexagonal ferrite as a crystal phase.

“Having a single phase as a crystal phase” mentioned herein means that in a case where a magnetoplumbite-type hexagonal ferrite having a certain makeup is measured by powder X-Ray-Diffraction (XRD), only one kind of diffraction pattern showing the crystal structure thereof is observed. In other words, this phrase means that a case where a plurality of magnetoplumbite-type hexagonal ferrites having certain makeups coexist and two or more kinds of diffraction patterns are observed or a case where a diffraction pattern of crystals other than the magnetoplumbite-type hexagonal ferrite is observed do not occur. For the attribution of the diffraction pattern, for example, the database of the International Center for Diffraction Data (ICDD, registered trademark) can be referred to. For example, for the diffraction pattern of a magnetoplumbite-type hexagonal ferrite containing Sr, “00-033-1340” of the International Center for Diffraction Data (ICDD) can be referred to. Here, the substitution of some of iron atom with aluminum causes the shift of peak position.

Whether the crystal phase of the magnetoplumbite-type hexagonal ferrite is a single phase can be confirmed, for example, by the X-ray diffraction (XRD) method as described above.

Specifically, for example, a measurement method performed under the following condition by using a powder X-ray diffractometer may be used.

As the measurement device, for example, a X'Pert Pro diffractometer from Malvern Panalytical Ltd can be suitably used. However, the measurement device is not limited to this.

### Condition

X-ray source: CuKα ray

(Wavelength: 1.54 Å (0.154 nm), output: 40 mA, 45 kV)

Scan range: 20°<2θ<70°

Scan interval: 0.05°

Scan speed: 0.75°/min

The electromagnetic wave absorbing particles (F1) can be prepared with reference to the description in WO2019/131675A.

The shape of the electromagnetic wave absorbing particles (F1) is not particularly limited, and examples thereof include a flat shape and an amorphous shape.

One kind of electromagnetic wave absorbing particles may be used alone, or two or more kinds of such particles may be used in combination.

In the composition, the content of the electromagnetic wave absorbing particles (total content in a case where the composition contains two or more kinds of electromagnetic wave absorbing particles) with respect to the total solid content of the composition is preferably 50.0% to 95.0% by mass, more preferably 65.0% to 90.0% by mass, and even more preferably 70.0% to 90.0% by mass. In the present specification, “total solid content” of the composition means all components except for solvents, and a liquid component is also regarded as a solid content.

In the composition, the content of the electromagnetic wave absorbing particles (total content in a case where the composition contains two or more kinds of electromagnetic wave absorbing particles) with respect to the total mass of the composition is preferably 10.0% to 99.0% by mass, more preferably 60.0% to 95.0% by mass, and even more preferably 60.0% to 80.0% by mass.

### Dispersant

The composition according to the aspect of the present invention contains a dispersant.

The content of the dispersant in the composition is not particularly limited. The content of the dispersant with respect to the total mass of the composition is preferably 1.0% to 10.0% by mass, more preferably 1.0% to 8.0% by mass, and even more preferably 1.0% to 5.0% by mass.

One kind of dispersant may be used alone, or two or more kinds of dispersants may be used in combination. In a case where two or more kinds of dispersants are used in combination, the total content thereof is preferably within the above range.

In the composition, the mass ratio of the content of the dispersant to the content of the electromagnetic wave absorbing particles (content of dispersant/content of electromagnetic wave absorbing particles) is preferably 0.010 to 1.5, more preferably 0.010 to 1.0, and even more preferably 0.020 to 0.065.

The dispersant is not particularly limited as long as it can disperse the aforementioned electromagnetic wave absorbing particles. Examples of the dispersant include a resin having a graft chain (hereinafter, also called “specific dispersing resin”), an anti-aggregation dispersant, an aggregation control agent, and the like. As the dispersant, in view of forming a film having higher electromagnetic wave absorption performance, particularly, a resin having a graft chain (specific dispersing resin) is preferable.

Although the molecular weight of the dispersant (weight-average molecular weight in a case where the dispersant has a molecular weight distribution) is not particularly limited, the upper limit of the molecular weight is preferably 300,000 or less, more preferably 200,000 or less, even more preferably 100,000 or less, and particularly preferably 50,000 or less. The lower limit of the molecular weight is, for example, preferably 3,000 or more, more preferably 4,000 or more, even more preferably 5,000 or more, and particularly preferably 6,000 or more. The molecular weight (weight-average molecular weight in a case where the dispersant has a molecular weight distribution) is particularly preferably 5,000 to 50,000.

### Specific Dispersing Resin

Hereinafter, the specific dispersing resin will be described.

### Repeating Unit Having Graft Chain

The specific dispersing resin is a resin having a graft chain, and is preferably a resin containing a repeating unit having a graft chain.

The longer the graft chain, the higher the effect of steric repulsion, which further improves the dispersion stability of the electromagnetic wave absorbing particles. In contrast, in a case where the graft chain is too long, the adsorptive force with respect to the electromagnetic wave absorbing particles is reduced, which sometimes decreases the dispersion stability of the electromagnetic wave absorbing particles. Therefore, the number of atoms constituting the graft chain excluding a hydrogen atom is preferably 40 to 10,000, more preferably 50 to 2,000, and even more preferably 60 to 500.

The graft chain mentioned herein refers to a portion from the root of the main chain (atom bonded to the main chain in a group branching off from the main chain) to the terminal of the group branching off from the main chain.

It is preferable that the graft chain contain a polymer structure. Examples of such a polymer structure include a poly(meth)acrylate structure (for example, a poly(meth)acrylic structure), a polyester structure, a polyurethane structure, a polyurea structure, a polyamide structure, a polyether structure, and the like.

In order to improve the interactivity between the graft chain and a solvent so that the dispersion stability of the electromagnetic wave absorbing particles is improved, the graft chain is preferably a graft chain containing at least one kind of structure selected from the group consisting of a polyester structure, a polyether structure, and a poly(meth)acrylate structure, and more preferably a graft chain containing at least either a polyester structure or a polyether structure.

The macromonomer having the aforementioned graft chain (monomer that has a polymer structure and is bonded to a main chain to configure a graft chain) is not particularly limited. As this macromonomer, a macromonomer containing a reactive double bond-forming group can be suitably used.

Examples of commercially available macromonomers that correspond to the aforementioned repeating unit having a graft chain and suitably used for the synthesis of the specific dispersing resin include AA-6, AA-10, AB-6, AS-6, AN-6, AW-6, AA-714, AY-707, AY-714, AK-5, AK-30, and AK-32 (all are trade names, manufactured by TOAGOSEI CO., LTD.), and BLEMMER PP-100, BLEMMER PP-500, BLEMMER PP-800, BLEMMER PP-1000, BLEMMER 55-PET-800, BLEMMER PME-4000, BLEMMER PSE-400, BLEMMER PSE-1300, and BLEMMER 43PAPE-600B (all are trade names, manufactured by NOF CORPORATION.). Among these, AA-6, AA-10, AB-6, AS-6, AN-6, or BLEMMER PME-4000 are preferable.

The specific dispersing resin preferably contains at least one kind of structure selected from the group consisting of polymethyl acrylate, polymethyl methacrylate, and cyclic or chain-like polyester, more preferably contains at least one kind of structure selected from the group consisting of polymethyl acrylate, polymethyl methacrylate, and chain-like polyester, and even more preferably contains at least one kind of structure selected from the group consisting of a polymethyl acrylate structure, a polymethyl methacrylate structure, a polycaprolactone structure, and a polyvalerolactone structure. The specific dispersing resin may contain only one kind of the aforementioned structure or a plurality of the aforementioned structures.

The polycaprolactone structure mentioned herein refers to a structure containing, as a repeating unit, a structure formed by ring opening of ε-caprolactone. The polyvalerolactone structure refers to a structure containing, as a repeating unit, a structure formed by ring opening of δ-valerolactone.

In a case where the specific dispersing resin contains repeating units represented by Formula (1) and Formula (2), which will be described later, where each of j and k is 5, the aforementioned polycaprolactone structure can be introduced into the specific dispersing resin.

In a case where the specific dispersing resin contains repeating units represented by Formula (1) and Formula (2), which will be described later, where each of j and k is 4, the aforementioned polyvalerolactone structure can be introduced into the specific dispersing resin.

In a case where the specific dispersing resin contains a repeating unit represented by Formula (4), which will be described later, where X⁵ is a hydrogen atom and R⁴ is a methyl group, the aforementioned polymethyl acrylate structure can be introduced into the specific dispersing resin.

In a case where the specific dispersing resin contains a repeating unit represented by Formula (4), which will be described later, where X⁵ and R⁴ both represent a methyl group, the aforementioned polymethyl methacrylate structure can be introduced into the specific dispersing resin.

As the repeating unit having a graft chain that the specific dispersing resin is to contain, a repeating unit represented by any of the following Formula (1) to Formula (4) is preferable, and a repeating unit represented by any of the following Formula (1A), the following Formula (2A), the following Formula (3A), the following Formula (3B), and the following Formula (4) is more preferable.

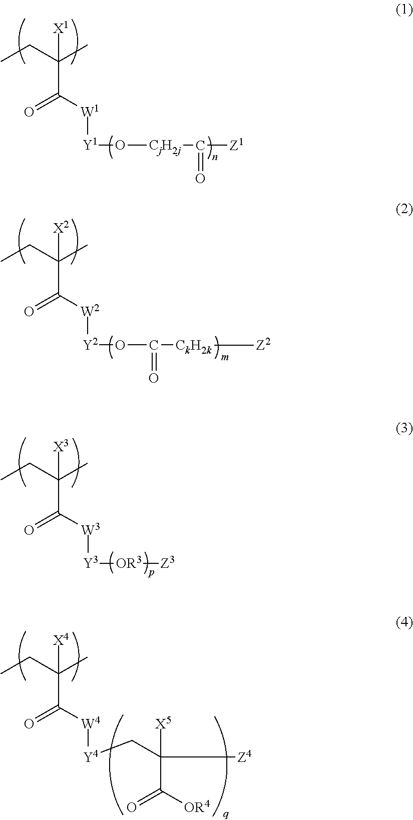

In Formulas (1) to (4), W¹, W², W³, and W⁴ each independently represent an oxygen atom or NH. W¹, W², W³, and W⁴ are preferably oxygen atoms.

In Formulas (1) to (4), X¹, X², X³, X⁴, and X⁵ each independently represent a hydrogen atom or a monovalent organic group. In view of restrictions on synthesis, X¹, X², X³, X⁴, and X⁵ preferably each independently represent a hydrogen atom or an alkyl group with a carbon number (the number of carbon atoms) of 1 to 12, more preferably each independently represent a hydrogen atom or a methyl group, and even more preferably each independently represent a methyl group.

In Formulas (1) to (4), Y¹, Y², Y³, and Y⁴ each independently represent a divalent linking group. The structure of the linking group is not particularly restricted. Specific examples of the divalent linking group represented by Y¹, Y², Y³, and Y⁴ include the following linking groups (Y-1) to (Y-21) and the like. In the following structures, A means a bonding site to the left terminal group in Formulas (1) to (4), and B means a bonding site to the right terminal group in Formulas (1) to (4). Among the following structures, in view of ease of synthesis, (Y-2) or (Y-13) is more preferable.

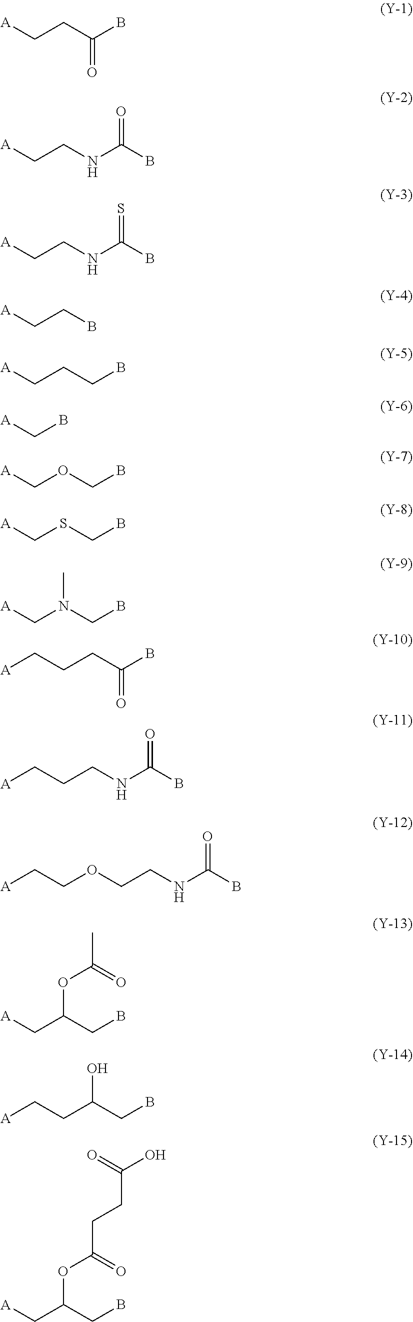

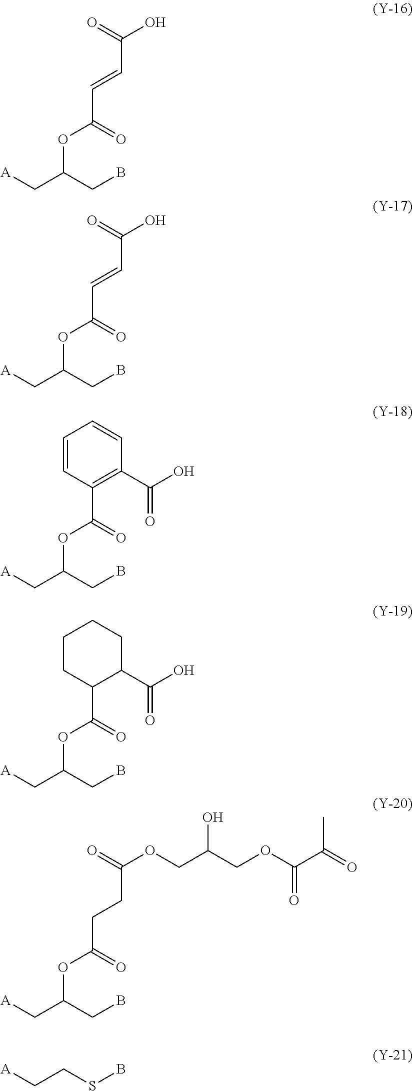

In Formulas (1) to (4), Z¹, Z², Z³, and Z⁴ each independently represent a monovalent organic group. The structure of the organic group is not particularly limited. Specific examples of the organic group include an alkyl group, a hydroxyl group, an alkoxy group, an aryloxy group, a heteroaryloxy group, an alkylthioether group, an arylthioether group, a heteroarylthioether group, an amino group, and the like. Among these, as the organic group represented by Z¹, Z², Z³, and Z⁴, particularly, in view of improving dispersion stability, a group that brings about a steric repulsion effect is preferable. Z¹, Z², Z³, and Z⁴ more preferably each independently represent an alkyl or alkoxy group with a carbon number of 5 to 24. Especially, Z¹, Z², Z³, and Z⁴ even more preferably each independently represent a branched alkyl group with a carbon number of 5 to 24, a cyclic alkyl group with a carbon number of 5 to 24, or an alkoxy group with a carbon number of 5 to 24. Note that the alkyl group contained in the alkoxy group may be linear, branched, or cyclic.

In Formulas (1) to (4), n, m, p, and q each independently represent an integer of 1 to 500.

In Formulas (1) and (2), j and k each independently represent an integer of 2 to 8. In view of further improving the dispersion stability of the electromagnetic wave absorbing particles in the composition, each of j and k in Formulas (1) and (2) is preferably an integer of 4 to 6, and more preferably 5.

In Formulas (1) and (2), each of n and m is preferably an integer of 10 or more, and more preferably an integer of 20 or more. In a case where the specific dispersing resin contains a polycaprolactone structure and a polyvalerolactone structure, the sum of the repetition number of the polycaprolactone structure and the repetition number of polyvalerolactone is preferably an integer of 10 or more, and more preferably an integer of 20 or more.

In Formula (3), R³ represents a branched or linear alkylene group which is preferably an alkylene group with a carbon number of 1 to 10, and more preferably an alkylene group with a carbon number of 2 or 3. In a case where p is 2 to 500, a plurality of R³'s may be the same or different from each other.

In Formula (4), R⁴ represents a hydrogen atom or a monovalent organic group, and the structure of the monovalent organic group is not particularly limited. R⁴ is preferably a hydrogen atom, an alkyl group, an aryl group, or a heteroaryl group, and more preferably a hydrogen atom or an alkyl group. In a case where R⁴ is an alkyl group, the alkyl group is preferably a linear alkyl group with a carbon number of 1 to 20, a branched alkyl group with a carbon number of 3 to 20, or a cyclic alkyl group with a carbon number of 5 to 20, more preferably a linear alkyl group with a carbon number of 1 to 20, and even more preferably a linear alkyl group with a carbon number of 1 to 6. In a case where q in Formula (4) is 2 to 500, a plurality of X⁵'s and R⁴'s in the graft chain may be the same or different from each other.

The specific dispersing resin may contain two or more kinds of repeating units having different structures and having a graft chain. That is, the molecule of the specific dispersing resin may contain repeating units represented by Formulas (1) to (4) having different structures. Furthermore, in a case where n, m, p, and q in Formulas (1) to (4) each represent an integer of 2 or more, the side chains in Formulas (1) and (2) may contain structures where j and k represent different integers, and a plurality of R³'s, R⁴'s, and X⁵'s in the molecules of Formulas (3) and (4) may be the same or different from each other.

In view of further improving the dispersion stability of the electromagnetic wave absorbing particles in the composition, the repeating unit represented by Formula (1) is more preferably a repeating unit represented by the following Formula (1A).

In view of further improving the dispersion stability of the electromagnetic wave absorbing particles in the composition, the repeating unit represented by Formula (2) is more preferably a repeating unit represented by the following Formula (2A).

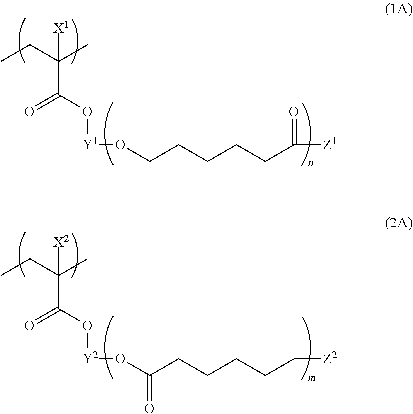

X¹, Y¹, Z¹, and n in Formula (1A) have the same definitions as X¹, Y¹, Z¹, and n in Formula (1), and preferable ranges thereof are the same as well. X², Y², Z², and m in Formula (2A) have the same definitions as X², Y², Z², and m in Formula (2), and preferable ranges thereof are the same as well.

In view of further improving the dispersion stability of the electromagnetic wave absorbing particles in the composition, the repeating unit represented by Formula (3) is more preferably a repeating unit represented by the following Formula (3A) or Formula (3B).

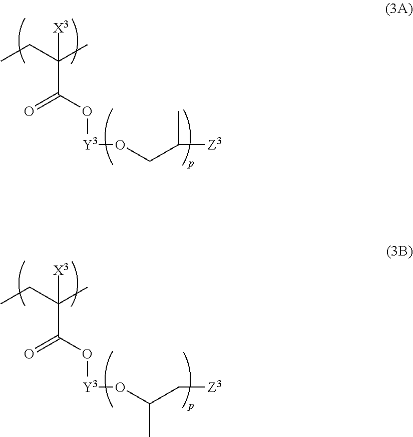

X³, Y³, Z³, and p in Formula (3A) or (3B) have the same definitions as X³, Y³, Z³, and p in Formula (3), and preferable ranges thereof are the same as well.

In view of further improving the dispersion stability of the electromagnetic wave absorbing particles in the composition, it is more preferable that the specific dispersing resin contain the repeating unit represented by Formula (1A) as the repeating unit having a graft chain

It is also preferable that the specific dispersing resin contain a repeating unit containing a polyalkylene imine structure and a polyester structure. It is preferable that the repeating unit containing a polyalkylene imine structure and a polyester structure contain the polyalkylene imine structure in the main chain and contain the polyester structure as a graft chain.

The polyalkylene imine structure is a polymerization structure having two or more identical or different alkylene imine chains Specific examples of the alkylene imine chain include alkylene imine chains represented by the following Formula (4A) and the following Formula (4B).

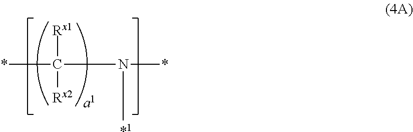

In Formula (4A), R^{x1} and R^{x2} each independently represent a hydrogen atom or an alkyl group. a¹ represents an integer of 2 or more. *¹ represents a bonding position to a polyester chain, an adjacent alkylene imine chain, a hydrogen atom, or a substituent.

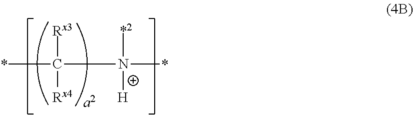

In Formula (4B), R^{x3} and R^{x4} each independently represent a hydrogen atom or an alkyl group. a² represents an integer of 2 or more. The alkylene imine chain represented by Formula (4B) is bonded to a polyester chain having an anionic group by the formation of a salt crosslinking group of N⁺ shown in Formula (4B) and an anionic group contained in the polyester chain.

* in Formula (4A) and Formula (4B) and *² in Formula (4B) each independently represent a position to be bonded to an adjacent alkylene imine chain, a hydrogen atom, or a substituent.

* in Formula (4A) and Formula (4B) particularly preferably represent a position to be bonded to an adjacent alkylene imine chain.

R^{X1} and R^{X2} in Formula (4A) and R^{X3} and R^{X4} in Formula (4B) each independently represent a hydrogen atom or an alkyl group.

The carbon number of the alkyl group is preferably 1 to 6, and more preferably 1 to 3.

It is preferable that R^{x1} and R^{x2} in Formula (4A) both represent a hydrogen atom.

It is preferable that R^{x3} and R^{x4} in Formula (4B) both represent a hydrogen atom.

a¹ in Formula (4A) and a² in Formula (4B) are not particularly limited as long as a¹ and a² each represent an integer of 2 or more. The upper limit of a¹ and a² is preferably 10 or less, more preferably 6 or less, even more preferably 4 or less, still more preferably 2 or 3, and particularly preferably 2.

* in Formula (4A) and Formula (4B) represents a bonding position to an adjacent alkylene imine chain, a hydrogen atom, or a substituent.

Examples of the aforementioned substituent include a substituent such as an alkyl group (for example, an alkyl group with a carbon number of 1 to 6). Furthermore, a polyester chain may be bonded thereto as a substituent.

The alkylene imine chain represented by Formula (4A) is preferably linked to the polyester chain at the position represented by *¹ described above. Specifically, it is preferable that the carbonyl carbon in the polyester chain be bonded at the position represented by *¹ described above.

Examples of the polyester chain include a polyester chain represented by the following formula (5A).

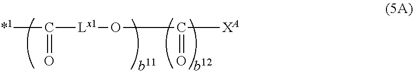

In a case where the alkylene imine chain is an alkylene imine chain represented by Formula (4B), it is preferable that the polyester chain contain an anionic group (preferably an oxygen anion O⁻), and that the anionic group and N⁺ in Formula (4B) form a salt crosslinking group.

Examples of such a polyester chain include a polyester chain represented by the following Formula (5B).

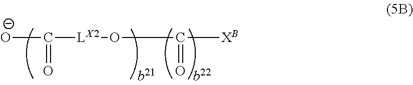

L^{X1} in Formula (5A) and L^{X2} in Formula (5B) each independently represent a divalent linking group. Preferable examples of the divalent linking group include an alkylene group with a carbon number of 3 to 30.

b¹¹ in Formula (5A) and b²¹ in Formula (5B) each independently represent an integer of 2 or more. The upper limit thereof is, for example, 200 or less.

b¹² in Formula (5A) and b²² in Formula (5B) each independently represent 0 or 1.

X^{A} in Formula (5A) and X^{B} in Formula (5B) each independently represent a hydrogen atom or a substituent. Examples of the substituent include an alkyl group, an alkoxy group, a polyalkyleneoxyalkyl group, an aryl group, and the like.

The carbon number of the aforementioned alkyl group (the alkyl group may be any of linear, branch, and cyclic alkyl groups) and the carbon number of an alkyl group (the alkyl group may be any of linear, branch, and cyclic alkyl groups) contained in the aforementioned alkoxy group are, for example, 1 to 30, and preferably 1 to 10. The aforementioned alkyl group may further have a substituent. Examples of the substituent include a hydroxyl group and a halogen atom (the halogen atom includes a fluorine atom, a chlorine atom, a bromine atom, an iodine atom, and the like).

The polyalkyleneoxyalkyl group is a substituent represented by R^{X6}(OR^{X7})ₚ(O)_{q}—. R^{X6} represents an alkyl group, R^{X7} represents an alkylene group, p represents an integer of 2 or more, and q represents 0 or 1.

The alkyl group represented by R^{X6} has the same definition as the alkyl group represented by X^{A}. Examples of the alkylene group represented by R^{X} include a group obtained by removing one hydrogen atom from the alkyl group represented by X^{A}.

p is an integer of 2 or more, and the upper limit thereof is, for example, 10 or less, and preferably 5 or less.

Examples of the aryl group include an aryl group (which may be monocyclic or polycyclic) with a carbon number of 6 to 24.

The aforementioned aryl group may further have a substituent. Examples of the substituent include an alkyl group, a halogen atom, a cyano group, and the like.

The aforementioned polyester chain is preferably a structure established by ring opening of lactones such as ε-caprolactone, δ-caprolactone, β-propiolactone, γ-butyrolactone, δ-valerolactone, γ-valerolactone, enanthonolactone, β-butyrolactone, γ-hexanolactone, and γ-octanolactone, δ-hexanolactone, δ-octanolactone, δ-dodecanolactone, α-methyl-γ-butyrolactone, and lactide (which may be L-lactide or D-lactide), and more preferably a structure established by ring opening of ε-caprolactone or δ-valerolactone.

The aforementioned repeating unit containing a polyalkylene imine structure and a polyester structure can be synthesized according to the synthesis method described in JP5923557B.

In the specific dispersing resin, the content of the repeating unit having a graft chain expressed in terms of mass with respect to the total mass of the specific dispersing resin is preferably 2% to 95% by mass, more preferably 2% to 90% by mass, and particularly preferably 5% to 30% by mass. In a case where the content of the repeating unit having a graft chain is in this range, the electromagnetic wave absorbing particles have high dispersion stability, and a cured film is formed with excellent developability.

### Hydrophobic Repeating Unit

It is also preferable that the specific dispersing resin contain a hydrophobic repeating unit that is different from the repeating unit having a graft chain (that is, does not correspond to the repeating unit having a graft chain). In the present specification, the hydrophobic repeating unit refers to a repeating unit having no acid group (for example, a carboxylic acid group, a sulfonic acid group, a phosphoric acid group, a phenolic hydroxyl group, and the like).

The hydrophobic repeating unit is preferably a repeating unit derived from (corresponding to) a compound (monomer) having a C log P value of 1.2 or more, and is more preferably a repeating unit derived from a compound having a C log P value of 1.2 to 8. In a case where this hydrophobic repeating unit is used, the effects of the present invention can be more reliably expressed.

The C log P value is a value calculated by a program “CLOGP” available from Daylight Chemical Information System, Inc. This program provides a value of “calculated log P” calculated by the fragment approach (see the following documents) of Hansch and Leo. The fragment approach is based on the chemical structure of a compound. In this method, the chemical structure is divided into partial structures (fragments), and degrees of contribution to log P that are assigned to the fragments are summed up, thereby estimating the log P value of the compound. Details of the method are described in the following documents. In the present specification, a C log P value calculated by a program CLOGP v 4.82 is used.

A. J. Leo, Comprehensive Medicinal Chemistry, Vol. 4, C. Hansch, P. G. Sammnens, J. B. Taylor and C. A. Ramsden, Eds., p. 295, Pergamon press, 1990, C. Hansch & A. J. Leo. Substituent Constants For Correlation Analysis in Chemistry and Biology. John Wiley & Sons. A. J. Leo. Calculating log Poct from structure. Chem. Rev., 93, 1281-1306, 1993.

log P means a common logarithm of a partition coefficient P. log P is a value of physical properties that shows how a certain organic compound is partitioned in an equilibrium of two-phase system consisting of oil (generally, 1-octanol) and water by using a quantitative numerical value. log P is represented by the following equation.

log P=log(Coil/Cwater)

In the formula, Coil represents a molar concentration of a compound in an oil phase, and Cwater represents a molar concentration of the compound in a water phase.

The greater the positive log P value based on 0, the higher the oil solubility. The greater the absolute value of negative log P, the higher the water solubility. The value of log P is negatively correlated with the water solubility of an organic compound, and widely used as a parameter for estimating the hydrophilicity and hydrophobicity of an organic compound.

It is preferable that the specific dispersing resin contain, as the hydrophobic repeating unit, one or more kinds of repeating units selected from repeating units derived from the monomers represented by the following Formulas (i) to (iii).

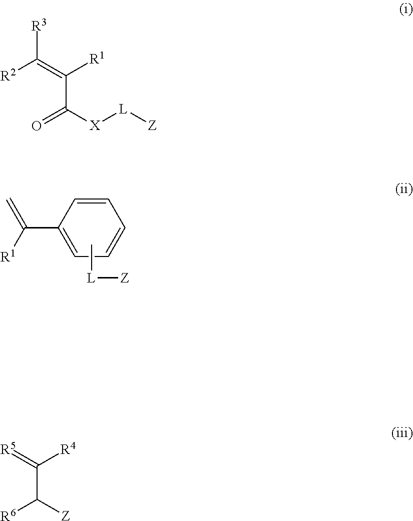

In the above Formulas (i) to (iii), R¹, R², and R³ each independently represent a hydrogen atom, a halogen atom (for example, a fluorine atom, a chlorine atom, a bromine atom, or the like), or an alkyl group with a carbon number of 1 to 6 (for example, a methyl group, an ethyl group, a propyl group, or the like).

Each of R¹, R², and R³ is preferably a hydrogen atom or an alkyl group with a carbon number of 1 to 3, and more preferably a hydrogen atom or a methyl group. Each of R² and R³ is more preferably a hydrogen atom.

X represents an oxygen atom (—O—) or an imino group (—NH—), and is preferably an oxygen atom.

L represents a single bond or a divalent linking group. Examples of the divalent linking group include a divalent aliphatic group (for example, an alkylene group, a substituted alkylene group, an alkenylene group, a substituted alkenylene group, an alkynylene group, or a substituted alkynylene group), a divalent aromatic group (for example, an arylene group or a substituted arylene group), a divalent heterocyclic group, an oxygen atom (—O—), a sulfur atom (—S—), an imino group (—NH—), a substituted imino group (—NR³¹—, where R³¹ is an aliphatic group, an aromatic group, or a heterocyclic group), a carbonyl group (—CO—), a combination of these, and the like.

The divalent aliphatic group may have a cyclic structure or a branched structure. The carbon number of the aliphatic group is preferably 1 to 20, more preferably 1 to 15, and even more preferably 1 to 10. The aliphatic group may be an unsaturated aliphatic group or a saturated aliphatic group, and is preferably a saturated aliphatic group. Furthermore, the aliphatic group may have a substituent. Examples of the substituent include a halogen atom, an aromatic group, a heterocyclic group, and the like.

The carbon number of the divalent aromatic group is preferably 6 to 20, more preferably 6 to 15, and even more preferably 6 to 10. Furthermore, the aromatic group may have a substituent. Examples of the substituent include a halogen atom, an aliphatic group, an aromatic group, a heterocyclic group, and the like.

It is preferable that the divalent heterocyclic group contain a 5-membered ring or a 6-membered ring as the heterocycle. Another heterocycle, aliphatic ring, or aromatic ring may be condensed with the heterocycle. Furthermore, the heterocyclic group may have a substituent. Examples of the substituent include a halogen atom, a hydroxyl group, an oxo group (═O), a thioxo group (═S), an imino group (═NH), a substituted imino group (═N—R³², where R³² is an aliphatic group, an aromatic group, or a heterocyclic group), an aliphatic group, an aromatic group, and a heterocyclic group.

L is preferably a single bond or a divalent linking group containing an alkylene group or an oxyalkylene structure. The oxyalkylene structure is more preferably an oxyethylene structure or an oxypropylene structure. Furthermore, L may contain a polyoxyalkylene structure containing two or more repeating oxyalkylene structures. As the polyoxyalkylene structure, a polyoxyethylene structure or a polyoxypropylene structure is preferable. The polyoxyethylene structure is represented by —(OCH₂CH₂)ₙ—. n is preferably an integer of 2 or more, and more preferably an integer of 2 to 10.

Examples of Z include an aliphatic group (for example, an alkyl group, a substituted alkyl group, an unsaturated alkyl group, or a substituted unsaturated alkyl group), an aromatic group (for example, an aryl group, a substituted aryl group, an arylene group, or a substituted arylene group), a heterocyclic group, and a combination of these. These groups may contain an oxygen atom (—O—), a sulfur atom (—S—), an imino group (—NH—), a substituted imino group (—NR³¹—, where R³¹ is an aliphatic group, an aromatic group, or a heterocyclic group), or a carbonyl group (—CO—).

The aliphatic group may have a cyclic structure or a branched structure. The carbon number of the aliphatic group is preferably 1 to 20, more preferably 1 to 15, and even more preferably 1 to 10. The aliphatic group further contains a ring assembly hydrocarbon group and a crosslinked cyclic hydrocarbon group. Examples of the ring assembly hydrocarbon group include a bicyclohexyl group, a perhydronaphthalenyl group, a biphenyl group, a 4-cyclohexylphenyl group, and the like. Examples of a crosslinked cyclic hydrocarbon ring include a bicyclic hydrocarbon ring such as a pinane, bornane, norpinane, norbornane, or bicyclooctane ring (such as a bicyclo[2.2.2]octane ring or a bicyclo[3.2.1]octane ring), a tricyclic hydrocarbon ring such as a homobredane, adamantane, tricyclo[5.2.1.0^{2,6}]decane, or tricyclo[4.3.1.1^{2,5}]undecane ring, a tetracyclic hydrocarbon ring such as a tetracyclo [4.4.0.1^{2,5}.1,10]dodecane or perhydro-1,4-methano-5,8-methanonaphthalene ring, and the like. In addition, the crosslinked cyclic hydrocarbon ring also includes fused hydrocarbon rings, for example, fused rings consisting of a plurality of condensed 5- to 8-membered cycloalkane rings such as perhydronaphthalene (decalin), perhydroanthracene, perhydrophenanthrene, perhydroacenaphtene, perhydrofluorene, perhydroindene, and perhydrophenanthrene rings.

As the aliphatic group, a saturated aliphatic group is preferred over an unsaturated aliphatic group. Furthermore, the aliphatic group may have a substituent. Examples of the substituent thereof include a halogen atom, an aromatic group, and a heterocyclic group. Here, the aliphatic group does not have an acid group as a substituent.

The carbon number of the aromatic group is preferably 6 to 20, more preferably 6 to 15, and even more preferably 6 to 10. Furthermore, the aromatic group may have a substituent. Examples of the substituent include a halogen atom, an aliphatic group, an aromatic group, and a heterocyclic group. Here, the aromatic group does not have an acid group as a substituent.

It is preferable that the heterocyclic group contain a 5-membered ring or a 6-membered ring as the heterocycle. Another heterocycle, aliphatic ring, or aromatic ring may be condensed with the heterocycle. Furthermore, the heterocyclic group may have a substituent. Examples of the substituent include a halogen atom, a hydroxyl group, an oxo group (═O), a thioxo group (═S), an imino group (═NH), a substituted imino group (═N—R³², where R³² is an aliphatic group, an aromatic group, or a heterocyclic group), an aliphatic group, an aromatic group, and a heterocyclic group. Here, the heterocyclic group does not have an acid group as a substituent.

In the above Formula (iii), R⁴, R⁵, and R⁶ each independently represent a hydrogen atom, a halogen atom (for example, a fluorine atom, a chlorine atom, a bromine atom, or the like), an alkyl group with a carbon number of 1 to 6 (for example, a methyl group, an ethyl group, a propyl group, or the like), Z, or L-Z. Here, L and Z have the same definition as the aforementioned groups represented by L and Z. Each of R⁴, R⁵, and R⁶ is preferably a hydrogen atom or an alkyl with a carbon number of 1 to 3, and more preferably a hydrogen atom.

As the monomer represented by the above Formula (i), a compound is preferably in which each of R¹, R², and R³ is a hydrogen atom or a methyl group, L is a single bond or a divalent linking group containing an alkylene group or an oxyalkylene structure, X is an oxygen atom or an imino group, and Z is an aliphatic group, a heterocyclic group, or an aromatic group.

As the monomer represented by the above Formula (ii), a compound is preferable in which R¹ is a hydrogen atom or a methyl group, L is an alkylene group, and Z is an aliphatic group, a heterocyclic group, or an aromatic group. Furthermore, as the monomer represented by the above Formula (iii), a compound is preferable in which each of R⁴, R⁵, and R⁶ is a hydrogen atom or a methyl group, and Z is an aliphatic group, a heterocyclic group, or an aromatic group.

Examples of typical compounds represented by Formulas (i) to (iii) include a radically polymerizable compound selected from acrylic acid esters, methacrylic acid esters, styrenes, and the like.

As examples of the typical compounds represented by Formulas (i) to (iii), the compounds described in paragraphs 0089 to 0093 of JP2013-249417A can be referred to, and what are described in the paragraphs are incorporated into the present specification.

In the specific dispersing resin, the content of the hydrophobic repeating unit, expressed in terms of mass, with respect to the total mass of the specific dispersing resin is preferably 10% to 90% by mass, and more preferably 20% to 80% by mass. In a case where the content is in this range, a pattern is sufficiently formed.

### Functional Group Capable of Interacting with Electromagnetic Wave Absorbing Particles

A functional group capable of interacting with the electromagnetic wave absorbing particles can be introduced into the specific dispersing resin. It is preferable that the specific dispersing resin further contain a repeating unit containing a functional group that is capable of interacting with the electromagnetic wave absorbing particles.

Examples of the functional group capable of interacting with the electromagnetic wave absorbing particles include an acid group, a basic group, a coordinating group, a reactive functional group, and the like.

In a case where the specific dispersing resin contains an acid group, a basic group, a coordinating group, or a reactive functional group, it is preferable that the specific dispersing resin contain a repeating unit containing an acid group, a repeating unit containing a basic group, a repeating unit containing a coordinating group, or a reactive repeating unit.

Especially, in a case where the specific dispersing resin further contains, as an acid group, an alkali-soluble group such as a carboxylic acid group, developability for forming a pattern by alkali development can be imparted to the specific dispersing resin.

That is, in a case where an alkali-soluble group is introduced into the specific dispersing resin, in the composition, the specific dispersing resin as a dispersant that contributes to the dispersion of the electromagnetic wave absorbing particles is soluble in an alkali. A non-exposed portion of the composition containing such a specific dispersing resin has improved alkali developability.

Furthermore, in a case where the specific dispersing resin contains a repeating unit containing an acid group, the specific dispersing resin is likely to be compatible with a solvent, and coating properties tend to be improved. Presumably, because the acid group in the repeating unit containing an acid group readily interacts with the electromagnetic wave absorbing particles, the specific dispersing resin may stably disperse the electromagnetic wave absorbing particles, the viscosity of the specific dispersing resin dispersing the electromagnetic wave absorbing particles may be reduced, which may enable the specific dispersing resin to be stably dispersed as well and improve coating properties.

The repeating unit containing an alkali-soluble group as an acid group may be a repeating unit that is the same as or different from the aforementioned repeating unit having a graft chain. However, the repeating unit containing an alkali-soluble group as an acid group is a repeating unit different from the aforementioned hydrophobic repeating unit (that is, does not correspond to the aforementioned hydrophobic repeating unit).

Examples of the acid group which is a functional group capable of interacting with the electromagnetic wave absorbing particles include a carboxylic acid group, a sulfonic acid group, a phosphoric acid group, a phenolic hydroxyl group, and the like. The acid group is preferably at least one kind of group among a carboxylic acid group, a sulfonic acid group, and a phosphoric acid group, and more preferably a carboxylic acid group. The carboxylic acid group has excellent adsorptive force with respect to the electromagnetic wave absorbing particles and has high dispersion stability.

That is, it is preferable that the specific dispersing resin further contain a repeating unit containing at least one kind of group among a carboxylic acid group, a sulfonic acid group, and a phosphoric acid group.

The specific dispersing resin may have one kind of repeating unit containing an acid group or two or more kinds of such repeating units.

In a case where the specific dispersing resin contains the repeating unit containing an acid group, the content of the repeating unit expressed in terms of mass with respect to the total mass of the specific dispersing resin is preferably 5% to 80% by mass, and more preferably 10% to 60% by mass.

Examples of the basic group which is a functional group capable of interacting with the electromagnetic wave absorbing particles include a primary amino group, a secondary amino group, a tertiary amino group, a heterocycle containing a N atom, an amide group, and the like. As the basic group, in view of excellent adsorptive force with respect to the electromagnetic wave absorbing particles and high dispersion stability, a tertiary amino group is preferable. The specific dispersing resin may contain one kind of basic group described above or two or more kinds of basic groups described above.

In a case where the specific dispersing resin contains the repeating unit containing a basic group, the content of the repeating unit expressed in terms of mass with respect to the total mass of the specific dispersing resin is preferably 0.01% to 50% by mass, and more preferably 0.01% to 30% by mass.

Examples of the coordinating group and the reactive functional group which are functional groups capable of interacting with the electromagnetic wave absorbing particles include an acetylacetoxy group, a trialkoxysilyl group, an isocyanate group, an acid anhydride, an acid chloride, and the like. As these functional groups, in view of excellent adsorptive force with respect to the electromagnetic wave absorbing particles and high dispersion stability of the electromagnetic wave absorbing particles, an acetylacetoxy group is preferable. The specific dispersing resin may have one kind of these groups or two or more kinds of these groups.

In a case where the specific dispersing resin contains the repeating unit containing a coordinating group or the repeating unit containing a reactive functional group, the content of the repeating unit expressed in terms of mass with respect to the total mass of the specific dispersing resin is preferably 10% to 80% by mass, and more preferably 20% to 60% by mass.

In a case where the specific dispersing resin contains, in addition to the graft chain, a functional group capable of interacting with the electromagnetic wave absorbing particles, the specific dispersing resin may contain functional groups capable of interacting with various electromagnetic wave absorbing particles described above, and the way the functional groups are introduced into the specific dispersing resin is not particularly limited. However, it is preferable that the specific dispersing resin contain one or more kinds of repeating units selected from repeating units derived from monomers represented by the following Formulas (iv) to (vi).

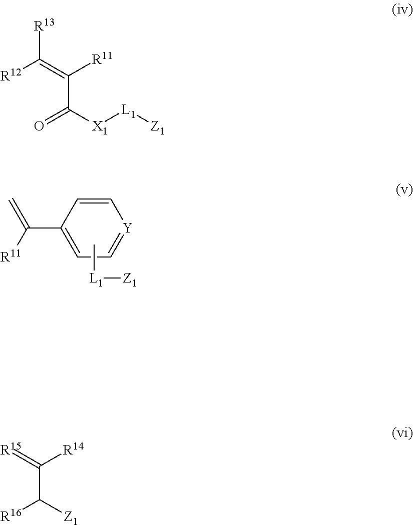

In Formulas (iv) to (vi), R¹¹, R¹², and R¹³ each independently represent a hydrogen atom, a halogen atom (for example, a fluorine atom, a chlorine atom, a bromine atom, or the like), or an alkyl group with a carbon number of 1 to 6 (for example, a methyl group, an ethyl group, a propyl group, or the like).

In Formulas (iv) to (vi), each of R¹¹, R¹², and R¹³ is preferably a hydrogen atom or an alkyl group with a carbon number of 1 to 3, and more preferably a hydrogen atom or a methyl group. Each of R¹² and R¹³ in Formula (iv) is even more preferably a hydrogen atom.

X₁ in Formula (iv) represents an oxygen atom (—O—) or an imino group (—NH—), and is preferably an oxygen atom.

Y in Formula (v) represents a methine group or a nitrogen atom.

L₁ in Formulas (iv) to (v) represents a single bond or a divalent linking group. The divalent linking group has the same definition as the divalent linking group represented by L in Formula (i) described above.

L₁ is preferably a single bond or a divalent linking group containing an alkylene group or an oxyalkylene structure. The oxyalkylene structure is more preferably an oxyethylene structure or an oxypropylene structure. Furthermore, L₁ may contain a polyoxyalkylene structure including two or more repeating oxyalkylene structures. As the polyoxyalkylene structure, a polyoxyethylene structure or a polyoxypropylene structure is preferable. The polyoxyethylene structure is represented by —(OCH₂CH₂)ₙ—. n is preferably an integer of 2 or more, and more preferably an integer of 2 to 10.

In Formulas (iv) to (vi), Z₁ represents a functional group that is capable of interacting with the electromagnetic wave absorbing particles as well in addition to the graft chain. Z₁ is preferably a carboxylic acid group or a tertiary amino group, and more preferably a carboxylic acid group.

In Formula (vi), R¹⁴, R¹⁵, and R¹⁶ each independently represent a hydrogen atom, a halogen atom (for example, a fluorine atom, a chlorine atom, a bromine atom, or the like), an alkyl group with a carbon number of 1 to 6 (for example, a methyl group, an ethyl group, a propyl group, or the like), —Z₁, or L₁-Z₁. Here, L₁ and Z₁ have the same definitions as L₁ and Z₁ described above, and preferable examples thereof are also the same. Each of R¹⁴, R¹⁵, and R¹⁶ is preferably a hydrogen atom or an alkyl with a carbon number of 1 to 3, and more preferably a hydrogen atom.

As the monomer represented by Formula (iv), a compound is preferable in which R¹¹, R¹², and R¹³ each independently represent a hydrogen atom or a methyl group, L₁ is a divalent linking group containing an alkylene group or an oxyalkylene structure, X₁ is an oxygen atom or an imino group, and Z₁ is a carboxylic acid group.

As the monomer represented by Formula (v), a compound is preferable in which R¹¹ is a hydrogen atom or a methyl group, L₁ is an alkylene group, Z₁ is a carboxylic acid group, and Y is a methine group.

Furthermore, as the monomer represented by Formula (vi), a compound is preferable in which R¹⁴, R¹⁵, and R¹⁶ each independently represent a hydrogen atom or a methyl group, and Z₁ is a carboxylic acid group.

Typical examples of the monomers (compounds) represented by Formulas (iv) to (vi) will be shown below.

Examples of the monomers include methacrylic acid, crotonic acid, isocrotonic acid, a reaction product of a compound containing an addition-polymerizable double bond and a hydroxyl group in a molecule (for example, 2-hydroxyethyl methacrylate) and a succinic anhydride, a reaction product of a compound containing an addition-polymerizable double bond and a hydroxyl group in a molecule and a phthalic anhydride, a reaction product of a compound containing an addition-polymerizable double bond and a hydroxyl group in a molecule and a tetrahydroxyphthalic anhydride, a reaction product of a compound containing an addition-polymerizable double bond and a hydroxyl group in a molecule and a trimellitic anhydride, a reaction product of a compound containing an addition-polymerizable double bond and a hydroxyl group in a molecule and a pyromellitic anhydride, acrylic acid, an acrylic acid dimer, an acrylic acid oligomer, maleic acid, itaconic acid, fumaric acid, 4-vinylbenzoic acid, vinylphenol, 4-hydroxyphenyl methacrylamide, and the like.

In view of interaction with the electromagnetic wave absorbing particles, temporal stability, and permeability with respect to a developer, the content of the repeating unit containing a functional group capable of interacting with the electromagnetic wave absorbing particles, the content being expressed in terms of mass, with respect to the total mass of the specific dispersing resin is preferably 0.05% to 90% by mass, more preferably 1.0% to 80% by mass, and even more preferably 10% to 70% by mass.

### Repeating Unit Containing Ethylenically Unsaturated Group or Ethylenically Unsaturated Group

It is preferable that the specific dispersing resin further contain an ethylenically unsaturated group. In a case where the specific dispersing resin contains an ethylenically unsaturated group, pattern forming properties of the composition containing the specific dispersing resin are further improved.

The aforementioned ethylenically unsaturated group is not particularly limited, and examples thereof include a (meth)acryloyl group, a vinyl group, a styryl group, and the like. Among these, a (meth)acryloyl group is preferable.

Particularly, the specific dispersing resin preferably contains a repeating unit that contains an ethylenically unsaturated group in a side chain, and more preferably contains a repeating unit that contains an ethylenically unsaturated group in a side chain and is derived from (meth)acrylate (hereinafter, such a repeating unit will be also called “(meth)acrylic repeating unit containing an ethylenically unsaturated group in a side chain”). The (meth)acrylic repeating unit containing an ethylenically unsaturated group in a side chain is obtained, for example, by causing an addition reaction between a carboxylic acid group in a resin containing a (meth)acrylic repeating unit containing the carboxylic acid group and an ethylenically unsaturated group-containing compound containing a glycidyl group or an alicyclic epoxy group.

In a case where the specific dispersing resin contains the repeating unit containing an ethylenically unsaturated group, the content of the repeating unit expressed in terms of mass with respect to the total mass of the specific dispersing resin is preferably 30% to 70% by mass, and more preferably 40% to 60% by mass. In a case where the content of the repeating unit containing an ethylenically unsaturated group is in the above range, further improved pattern forming properties are exhibited.

### Other Repeating Units

For the purpose of improving various performances such as film forming performance, as long as the effects of the present invention are not impaired, the specific dispersing resin may further contain other repeating units having various performances (for example, a repeating unit containing a functional group having affinity with the solvent which will be described later, and the like) different from the repeating unit having a graft chain, the hydrophobic repeating unit, the repeating unit containing a functional group capable of interacting with the electromagnetic wave absorbing particles, and the repeating unit containing an ethylenically unsaturated group.

Examples of those other repeating units include repeating units derived from radically polymerizable compounds selected from acrylonitriles, methacrylonitriles, and the like.

For the specific dispersing resin, one kind of those other repeating units or two or more kinds of those other repeating units can be used. The content of those other repeating units expressed in terms of mass with respect to the total mass of the specific dispersing resin is preferably 0% to 80% by mass, and more preferably 10% to 60% by mass.

### Physical Properties of Specific Dispersing Resin

The acid value of the specific dispersing resin is not particularly limited. For example, the acid value is preferably 0 to 250 mgKOH/g, more preferably 10 to 200 mgKOH/g, even more preferably 30 to 180 mgKOH/g, and particularly preferably in a range of 50 to 120 mgKOH/g.

In a case where the acid value of the specific dispersing resin is 160 mgKOH/g or less, pattern peeling that may occur at the time of development in the process of forming a cured film is more effectively suppressed. Furthermore, in a case where the acid value of the specific dispersing resin is 10 mgKOH/g or more, alkali developability is further improved. In addition, in a case where the acid value of the specific dispersing resin is 20 mgKOH/g or more, the sedimentation of the electromagnetic wave absorbing particles can be further suppressed, the number of coarse particles can be further reduced, and the temporal dispersion stability of the composition can be further improved.

In the present specification, the acid value can be calculated, for example, from the average content of acid groups in a compound. Furthermore, changing the content of the repeating unit containing an acid group in the resin makes it possible to obtain a resin having a desired acid value.

The weight-average molecular weight of the specific dispersing resin is not particularly limited. For example, the weight-average molecular weight is preferably 3,000 or more, more preferably 4,000 or more, even more preferably 5,000 or more, and particularly preferably 6,000 or more. The upper limit of the weight-average molecular weight is, for example, preferably 300,000 or less, more preferably 200,000 or less, even more preferably 100,000 or less, and particularly preferably 50,000 or less.

The specific dispersing resin can be synthesized based on a known method.

For specific examples of the specific dispersing resin, the polymer compounds described in paragraphs 0127 to 0129 of JP2013-249417A can be referred to, and what are described in the paragraphs are incorporated into the present specification.

As the specific dispersing resin, the graft copolymers in paragraphs 0037 to 0115 of JP2010-106268A (paragraphs 0075 to 0133 of US2011/0124824 corresponding to JP2010-106268A) can also be used, and what are described in the paragraphs can be cited and incorporated into the present specification.

### Aggregation Control Agent

The aggregation control agent refers to a substance which can be bonded to aggregates having a relatively low density, such as the electromagnetic wave absorbing particles, and can disperse optionally added other components (for example, the alkali-soluble resin and the like) in the composition so that bulky aggregates are formed.

In a case where the dispersant is an aggregation control agent, the electromagnetic wave absorbing particles in the composition are inhibited from forming a hard cake, and bulky aggregates are formed. Therefore, redispersibility can be improved.

Examples of the aggregation control agent include a cellulose derivative.

Examples of the cellulose derivative include carboxymethyl cellulose, methyl cellulose, hydroxyethyl cellulose, hydroxypropyl cellulose, hydroxypropyl methyl cellulose, hydroxypropyl ethyl cellulose, salts of these, and the like.

In a case where the dispersant is an aggregation control agent, in the composition, the content of the aggregation control agent with respect to the total mass of the composition is preferably 0.05% to 1.0% by mass, and more preferably 0.1% to 0.5% by mass.

One kind of aggregation control agent may be used alone, or two or more kinds of aggregation control agents may be used in combination. In a case where two or more kinds of aggregation control agents are used in combination, it is preferable that the content thereof be adjusted so that the total solid content of the composition falls in to the above range.

### Anti-Aggregation Dispersant

The anti-aggregation dispersant is a substance which can be adsorbed onto the surface of the electromagnetic wave absorbing particles, so that the electromagnetic wave absorbing particles remain spaced apart from each other by at least a certain distance and that the electromagnetic wave absorbing particles are prevented from being directly aggregated with each other. As a result, the aggregation of the electromagnetic wave absorbing particles is suppressed, and even in a case where aggregates are formed, the density of the formed aggregates is relatively low. Furthermore, other components (for example, an alkali-soluble resin and the like) optionally added to the composition can be dispersed in the composition, and bulky aggregates can be formed. Therefore, redispersibility can be improved.

As the anti-aggregation dispersant, an alkylolammonium salt of a polybasic acid is preferable.

The polybasic acid may have two or more acid groups. Examples thereof include an acidic polymer containing a repeating unit having an acid group (for example, polyacrylic acid, polymethacrylic acid, polyvinylsulfonic acid, polyphosphoric acid, and the like). Examples of polybasic acids other than the above include a polymer obtained by polymerizing an unsaturated fatty acid such as crotonic acid. The alkylolammonium salt of a polybasic acid is obtained by reacting these polybasic acids with alkylolammonium. The salt obtained by such a reaction usually contains the following partial structure.

—C(═O)—N(—R¹)(—R²—OH)

Here, R¹ is an alkyl group, and R² is an alkylene group.

The alkylolammonium salt of a polybasic acid is preferably a polymer containing a plurality of partial structures described above. In a case where the alkylolammonium salt of a polybasic acid is a polymer, the weight-average molecular weight thereof is preferably 1,000 to 100,000, and more preferably 5,000 to 20,000. The polymer of the alkylolammonium salt of a polybasic acid is bonded to the surface of the electromagnetic wave absorbing particles and forms a hydrogen bond with molecules of other anti-aggregation dispersants, so that the main chain structure of the polymer goes in between the electromagnetic wave absorbing particles and the electromagnetic wave absorbing particles are spaced apart from each other.

Examples of the anti-aggregation dispersant include Anti-Terra 203, Anti-Terra 204, Anti-Terra 206, and Anti-Terra 250 (all are trade names, manufactured by BYK-Chemie GmbH.): Anti-TerraU (trade name, manufactured by BYK-Chemie GmbH.): DISPER BYK-102, DISPER BYK-180, and DISPER BYK-191 (all are trade names, manufactured by BYK-Chemie GmbH.): TEGO Disper 630 and TEGO Disper 700 (all are trade names, manufactured by Evonik Degussa Japan Co., Ltd.), and the like.

In a case where the dispersant is an anti-aggregation dispersant, in the composition, the content of the anti-aggregation dispersant with respect to the total mass of the composition is preferably 2% to 70% by mass, and more preferably 3% to 50% by mass.

One kind of anti-aggregation dispersant may be used alone, or two or more kinds of anti-aggregation dispersants may be used in combination. In a case where two or more kinds of anti-aggregation dispersants are used in combination, it is preferable that the content thereof be adjusted so that the total solid content of the composition falls into the above range.

### Solvent

The composition according to the aspect of the present invention contains a solvent.

As the solvent, known solvents can be used without particular limitations.

The content of the solvent in the composition is not particularly limited. The content of the solvent is preferably set so that the solid content of the composition is 10.0% by mass or more, and more preferably set so that the solid content of the composition is 15.0% by mass or more. Furthermore, the content of the solvent is set so that the solid content of the composition is 90.0% by mass or less, and more preferably set so that the solid content of the composition is 85.0% by mass or less.

The content of the solvent in the composition is preferably 10.0% to 30.0% by mass with respect to the total mass of the composition.

One kind of solvent may be used alone, or two or more kinds of solvents may be used in combination. In a case where two or more kinds of solvents are used in combination, it is preferable that the content thereof be adjusted so that the total solid content of the composition falls into the above range.

Examples of the solvent include an organic solvent.

The organic solvent is not particularly limited, and examples thereof include acetone (56° C.), methyl ethyl ketone (79.6° C.), cyclohexane (81° C.), ethyl acetate (77.1° C.), ethylene dichloride (83.5° C. to 84.0° C.), tetrahydrofuran (66° C.), toluene (110.6° C.), ethylene glycol monomethyl ether (124° C.), ethylene glycol monoethyl ether (135° C.), ethylene glycol dimethyl ether (84° C.), propylene glycol monomethyl ether (121° C.), propylene glycol monoethyl ether (132.8° C.), acetylacetone (140° C.), cyclohexanone (155.6° C.), cycloheptanone (131° C.), diacetone alcohol (166° C.), ethylene glycol monomethyl ether acetate (144.5° C.), ethylene glycol ethyl ether acetate (145° C.), ethylene glycol monoisopropyl ether (141° C.), ethylene glycol monobutyl ether acetate (192° C.), 3-methoxypropanol (150° C.), methoxy methoxyethanol, diethylene glycol monomethyl ether (194° C.), diethylene glycol monoethyl ether (196° C.), diethylene glycol dimethyl ether (162° C.), diethylene glycol diethyl ether (188° C.), propylene glycol monomethyl ether acetate (146° C.), propylene glycol monoethyl ether acetate (160° C.), 3-methoxypropyl acetate (146° C.), N,N-dimethylformamide (153° C.), dimethyl sulfoxide (189° C.), γ-butyrolactone (204° C.), ethyl acetate (77.1° C.), butyl acetate (126° C.), methyl lactate (144° C.), N-methyl-2-pyrrolidone (202° C.), ethyl lactate (154° C.), and the like. All the numerical values written together with each solvent name are boiling points.

Particularly, in view of excellent dispersion stability of the composition and/or further improving developability, the boiling point of the solvent is preferably 110° C. to 170° C. The solvent is more preferably propylene glycol monomethyl ether acetate (146° C.), propylene glycol monomethyl ether (121° C.), or butyl acetate (126° C.).

### Alkali-Soluble Resin

The composition according to the aspect of the present invention may contain an alkali-soluble resin.

In the present specification, the alkali-soluble resin means a resin that contains a group (alkali-soluble group, for example, an acid group such as a carboxylic acid group) enhancing alkali solubility and is different from the specific dispersing resin described above. The resin mentioned herein means a component that dissolves in the composition and has a weight-average molecular weight of more than 2,000.

In the composition, the content of the alkali-soluble resin with respect to the total mass of the composition is preferably 0.1% to 40.0% by mass, more preferably 0.5% to 30.0% by mass, and even more preferably 1.0% to 25.0% by mass.

Furthermore, in the composition, the content of the alkali-soluble resin with respect to the total solid content of the composition is preferably 0.1% to 15.0% by mass, more preferably 0.5% to 15.0% by mass, and even more preferably 1.0% to 10.0% by mass.

One kind of alkali-soluble resin may be used alone, or two or more kinds of alkali-soluble resins may be used in combination. In a case where two or more kinds of alkali-soluble resins are used in combination, the total content thereof is preferably within the above range.

Examples of the alkali-soluble resin include a resin containing at least one alkali-soluble group in a molecule. Examples thereof include a polyhydroxystyrene resin, a polysiloxane resin, a (meth)acrylic resin, a (meth)acrylamide resin, a (meth)acrylic/(meth)acrylamide copolymer resin, an epoxy resin, a polyimide resin, and the like.

Specific examples of the alkali-soluble resin include a copolymer of an unsaturated carboxylic acid and an ethylenically unsaturated compound.

The unsaturated carboxylic acid is not particularly limited, and examples thereof include monocarboxylic acid such as (meth)acrylic acid, crotonic acid, and vinylacetic acid; dicarboxylic acids such as itaconic acid, maleic acid, and fumaric acid or acid anhydrides of these acids; polyvalent carboxylic acid monoesters such as mono(2-(meth)acryloyloxyethyl)phthalate; and the like.

Examples of copolymerizable ethylenically unsaturated compounds include methyl (meth)acrylate and the like. Furthermore, the compounds described in paragraphs 0027 of JP2010-097210A and paragraphs 0036 and 0037 of JP2015-068893A can also be used, and the what are described in the above paragraphs are incorporated into the present specification.

Furthermore, a compound that is a copolymerizable ethylenically unsaturated compound and contains an ethylenically unsaturated group in a side chain may also be used in combination. That is, the alkali-soluble resin may contain a repeating unit containing an ethylenically unsaturated group in a side chain.

As the ethylenically unsaturated group contained in a side chain, a (meth)acrylic acid group is preferable.

The repeating unit containing an ethylenically unsaturated group in a side chain is obtained, for example, by causing an addition reaction between a carboxylic acid group of a (meth)acrylic repeating unit containing the carboxylic acid group and an ethylenically unsaturated compound containing a glycidyl group or an alicyclic epoxy group.

As the alkali-soluble resin, an alkali-soluble resin containing a polymerizable group is also preferable.

Examples of the polymerizable group include an ethylenically unsaturated group (for example, a (meth)acryloyl group, a vinyl group, a styryl group, or the like), a cyclic ether group (for example, an epoxy group, an oxetanyl group, or the like), and the like. However, the polymerizable group is not limited to these.

As the polymerizable group, among these, in view of making it possible to control polymerization by a radical reaction, an ethylenically unsaturated group is preferable, and a (meth)acryloyl group is more preferable.

As the alkali-soluble resin containing a polymerizable group, an alkali-soluble resin having a polymerizable group in a side chain or the like is preferable. Examples of the alkali-soluble resin containing a polymerizable group include DIANAL NR series (manufactured by MITSUBISHI RAYON CO., LTD.), Photomer 6173 (COOH-containing polyurethane acrylic oligomer, manufactured by Diamond Shamrock Co., Ltd.), VISCOAT R-264 and KS Resist 106 (all are manufactured by manufactured by OSAKA ORGANIC CHEMICAL INDUSTRY LTD.), CYCLOMER P series (for example, ACA230AA) and PLACCEL CF200 series (all are manufactured by Daicel Corporation), Ebecryl 3800 (manufactured by DAICEL-ALLNEX LTD.), and ACRYCURE RD-F8 (manufactured by NIPPON SHOKUBAI CO., LTD.), and the like.

As the alkali-soluble resin, for example, it is possible to use a radical polymer containing a carboxylic acid group in a side chain described in JP1984-044615A (JP-559-044615A), JP1979-34327B (JP-S54-34327AB), JP1983-12577B (JP-S58-12577B), 1P1979-025957B (JP-S54-025957B), JP1979-092723B (JP-S54-092723B), JP1984-053836A (JP-559-053836A), and JP1984-071048A (JP-S59-071048A); an acetal-modified polyvinyl alcohol-based binder resin containing an alkali-soluble group described in EP993966B, EP1204000B, and JP2001-318463A; polyvinylpyrrolidone; polyethylene oxide; alcohol-soluble nylon, polyether as a reaction product of 2,2-bis-(4-hydroxyphenyl)-propane and epichlorohydrin, and the like; the polyimide resin described WO2008/123097A; and the like.

As the alkali-soluble resin, for example, the compounds described in paragraphs 0225 to 0245 of JP2016-075845A can also be used, and the what are described in the above paragraphs are incorporated into the present specification.

As the alkali-soluble resin, a polyimide precursor can also be used. The polyimide precursor means a resin obtained by causing an additional polymerization reaction between a compound containing an acid anhydride group and a diamine compound at 40° C. to 100° C.

Specific examples of the polyimide precursor include the compounds described in paragraphs 0011 to 0031 of JP2008-106250A, the compounds described in paragraphs 0022 to 0039 of JP2016-122101A, the compounds described in paragraphs 0061 to 0092 of JP2016-068401A, the resins described in paragraph 0050 of JP2014-137523A, the resins described in paragraph 0058 of JP2015-187676A, the resins described in paragraphs 0012 and 0013 of JP2014-106326A, and the like. What are described in the above paragraphs are incorporated into the present specification.

As the alkali-soluble resin, a [benzyl (meth)acrylate/(meth)acrylic acid/other addition-polymerizable vinyl monomers used if necessary] copolymer and an [allyl(meth)acrylate/(meth)acrylic acid/other addition-polymerizable vinyl monomers used if necessary] copolymer are preferable because these make film hardness, sensitivity, and developability well balanced.

One kind of the aforementioned other addition-polymerizable vinyl monomers may be used alone, or two or more kinds of such monomers may be used in combination.

In view of further improving moisture resistance of a cured film, the aforementioned copolymers preferably have a polymerizable group, and more preferably have an ethylenically unsaturated group such as a (meth)acryloyl group.

For example, monomers have a polymerizable group may be used as the aforementioned other addition-polymerizable vinyl monomers so that the polymerizable group is introduced into the copolymers. In addition, a polymerizable group (preferably an ethylenically unsaturated group such as a (meth)acryloyl group) may be introduced into some or all of one or more kinds of units derived from (meth)acrylic acid and/or one or more kinds of units derived from the aforementioned other addition-polymerizable vinyl monomers in the copolymers.

Examples of the aforementioned other addition-polymerizable vinyl monomers include methyl (meth)acrylate, a styrene-based monomer (such as hydroxystyrene), and an ether dimer.

Examples of the ether dimer include a compound represented by the following General Formula (ED1) and a compound represented by the following General Formula (ED2).

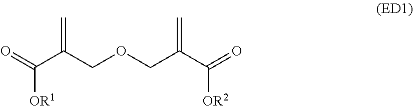

In General Formula (ED1), R¹ and R² each independently represent a hydrogen atom or a hydrocarbon group with a carbon number of 1 to 25.

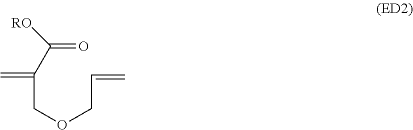

In General Formula (ED2), R represents a hydrogen atom or an organic group with a carbon number of 1 to 30. For specific examples of General Formula (ED2), the description of JP2010-168539A can be referred to.

For specific examples of the ether dimer, for example, paragraph 0317 of JP2013-029760A can be referred to, and what are described in the paragraph are incorporated into the present specification. Only one kind of ether dimer may be used alone, or two or more kinds of ether dimers may be used.

The acid value of the alkali-soluble resin is not particularly limited. Generally, the acid value is preferably 30 to 500 mgKOH/g, and more preferably 50 to 200 mgKOH/g.

### Polymerization Initiator

The composition may contain a polymerization initiator.

As the polymerization initiator, known polymerization initiators can be used without particular limitation. Examples of the polymerization initiator include a photopolymerization initiator, a thermal polymerization initiator, and the like. Among these, a photopolymerization initiator is preferable. As the polymerization initiator, a so-called radical polymerization initiator is preferable.

The content of the polymerization initiator in the composition is not particularly limited. The content of the polymerization initiator with respect to the total solid content of the composition is preferably 0.5% to 15.0% by mass, more preferably 1.0% to 10.0% by mass, and even more preferably 1.5% to 8.0% by mass.

One kind of polymerization initiator may be used alone, or two or more kinds of polymerization initiators may be used in combination. In a case where two or more kinds of polymerization initiators are used in combination, the total amount thereof is preferably within the above range.

### Thermal Polymerization Initiator

Examples of the thermal polymerization initiator include azo compounds such as 2,2′-azobisisobutyronitrile (AIBN), 3-carboxypropionitrile, azobismalenonitrile, and dimethyl-(2,2′)-azobis(2-methylpropionate) [V-601] and organic peroxides such as benzoyl peroxide, lauroyl peroxide, and potassium persulfate.

Specific examples of the thermal polymerization initiator include the polymerization initiators described on pages 65 to 148 of “Ultraviolet Curing System” by Kiyomi Kato (published by GL Sciences Inc.: 1989), and the like.

### Photopolymerization Initiator

It is preferable that the composition contain a photopolymerization initiator.

The photopolymerization initiator is not particularly limited as long as it can initiate the polymerization of the polymerizable compound. As the photopolymerization initiator, known photopolymerization initiators can be used. As the photopolymerization initiator, for example, a photopolymerization initiator sensitive to light ranging from an ultraviolet region to a visible light region is preferable. Furthermore, the photopolymerization initiator may be an activator that brings a certain action together with a photoexcited sensitizer and generates active radicals or an initiator that initiates cationic polymerization according to the type of polymerizable compound.

In addition, it is preferable that the photopolymerization initiator contain at least one kind of compound having molar absorption coefficient of at least 50 in a range of 300 to 800 nm (more preferably 330 to 500 nm).

The content of the photopolymerization initiator in the composition is not particularly limited. The content of the photopolymerization initiator with respect to the total solid content of the composition is preferably 0.5% to 15.0% by mass, more preferably 1.0% to 10.0% by mass, and even more preferably 1.5% to 8.0% by mass. One kind of photopolymerization initiator may be used alone, or two or more kinds of photopolymerization initiators may be used in combination. In a case where two or more kinds of photopolymerization initiators are used in combination, the total content thereof is preferably within the above range.

Examples of the photopolymerization initiator include halogenated hydrocarbon derivatives (for example, a compound containing a triazine skeleton, a compound containing an oxadiazole skeleton, and the like), acylphosphine compounds such as acylphosphine oxide, hexaarylbiimidazole, oxime compounds such as oxime derivatives, organic peroxides, thio compounds, ketone compounds, aromatic onium salts, aminoacetophenone compounds, hydroxyacetophenone, and the like.

For specific examples of the photopolymerization initiator, for example, paragraphs 0265 to 0268 of JP2013-029760A can be referred to, and what are described in the paragraphs are incorporated into the present specification.

More specifically, as the photopolymerization initiator, for example, the aminoacetophenone-based initiator described in JP1998-291969A (JP-H10-291969A) and the acylphosphine-based initiator described in JP4225898B can also be used.

As hydroxyacetophenone compounds, for example, IRGACURE-184, DAROCUR-1173, IRGACURE-500, IRGACURE-2959, and IRGACURE-127 (trade names, all are manufactured by BASF SE) can be used.

As aminoacetophenone compounds, for example, commercially available products, IRGACURE-907, IRGACURE-369, and IRGACURE-379EG (trade names, all are manufactured by BASF SE), can be used. As aminoacetophenone compounds, it is also possible to use the compound described in JP2009-191179A having an absorption wavelength matched with a long wavelength light source having a wavelength of 365 nm or a wavelength of 405 nm.

As acylphosphine compounds, commercially available products, IRGACURE-819 and IRGACURE-TPO (trade names, all are manufactured by BASF SE), can be used.

As the photopolymerization initiator, an oxime ester-based polymerization initiator (oxime compound) is more preferable. Particularly, an oxime compound is preferable because this compound has high sensitivity and high polymerization efficiency and makes it easy to design a high coloring material content in the composition.

Specifically, as the oxime compound, for example, the compound described in JP2001-233842A, the compound described in JP2000-80068A, or the compound described in JP2006-342166A can be used.

Examples of the oxime compound include 3-benzoyloxyiminobutan-2-one, 3-acetoxyiminobutan-2-one, 3-propionyloxyiminobutan-2-one, 2-acetoxyiminopentan-3-one, 2-acetoxyimino-1-phenylpropan-1-one, 2-benzoyloxyimino-1-phenylpropan-1-one, 3-(4-toluenesulfonyloxy)iminobutan-2-one, 2-ethoxycarbonyloxyimino-1-phenylpropan-1-one, and the like.

Examples of the oxime compound also include the compounds described in J. C. S. Perkin II (1979) pp. 1653-1660, J. C. S. Perkin II (1979) pp. 156-162, Journal of Photopolymer Science and Technology (1995) pp. 202-232, and JP2000-066385A, the compounds described in JP2000-080068A, JP2004-534797A, and JP2006-342166A, and the like.

As commercially available products, IRGACURE-OXE01 (manufactured by BASF SE), IRGACURE-OXE02 (manufactured by BASF SE), IRGACURE-OXE03 (manufactured by BASF SE), or IRGACURE-OXE04 (manufactured by BASF SE) is also preferable. In addition, TR-PBG-304 (manufactured by Changzhou Tronly New Electronic Materials Co., Ltd.), ADEKA ARKLS NCI-831 and ADEKA ARKLS NCI-930 (manufactured by ADEKA CORPORATION), or N-1919 (carbazoleoxime ester skeleton-containing photoinitiator (manufactured by ADEKA CORPORATION)) can also be used.

Furthermore, as oxime compounds other than the above, the compound described in JP2009-519904A in which oxime is linked to the N-position of carbazole; the compound described in US7626957B in which a hetero substituent is introduced into a benzophenone moiety; the compounds described in JP2010-015025A and US2009-292039A in which a nitro group is introduced into a dye moiety; the ketoxime compound described in WO2009-131189A; the compound described in U.S. Pat. No. 7,556,910B that contains a triazine skeleton and an oxime skeleton in the same molecule; the compound described in JP2009-221114A that has absorption maximum at 405 nm and has excellent sensitivity to a g-line light source; and the like may also be used.

For example, paragraphs 0274 and 0275 of JP2013-029760A can be referred to, and what are described in the paragraphs are incorporated into the present specification.

Specifically, as the oxime compound, a compound represented by the following Formula (OX-1) is preferable. The aforementioned oxime compound may be an oxime compound in which the N—O bond is an (E) isomer, an oxime compound in which the N—O bond is a (Z) isomer, or an oxime compound in which the N—O bond is a mixture of an (E) isomer and a (Z) isomer.

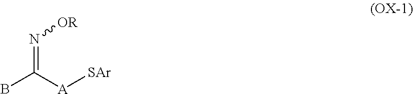

In Formula (OX-1), R and B each independently represent a monovalent substituent, A represents a divalent organic group, and Ar represents an aryl group.

In Formula (OX-1), as the monovalent substituent represented by R, a monovalent non-metal atomic group is preferable.

Examples of the monovalent non-metal atomic group include an alkyl group, an aryl group, an acyl group, an alkoxycarbonyl group, an aryloxycarbonyl group, a heterocyclic group, an alkylthiocarbonyl group, an arylthiocarbonyl group, and the like. Furthermore, these groups may have one or more substituents. In addition, the aforementioned substituents may be further substituted with another substituent.

Examples of the substituent include a halogen atom, an aryloxy group, an alkoxycarbonyl or aryloxycarbonyl group, an acyloxy group, an acyl group, an alkyl group, an aryl group, and the like.

As the monovalent substituent represented by B in Formula (OX-1), an aryl group, a heterocyclic group, an arylcarbonyl group, or a heterocyclic carbonyl group is preferable, and an aryl group or a heterocyclic group is more preferable. These groups may have one or more substituents. Examples of the substituents include the aforementioned substituents.

As the divalent organic group represented by A in Formula (OX-1), an alkylene group with a carbon number of 1 to 12, a cycloalkylene group, or an alkynylene group is preferable. These groups may have one or more substituents. Examples of the substituents include the aforementioned substituents.

As the photopolymerization initiator, an oxime compound containing a fluorine atom can also be used. Specific examples of the oxime compound containing a fluorine atom include the compounds described in JP2010-262028A; compounds 24 and 36 to 40 described in JP2014-500852A; the compound (C-3) described in JP2013-164471A; and the like. What are described in these documents are incorporated into the present specification.

As the photopolymerization initiator, compounds represented by the following General Formulas (1) to (4) can also be used.

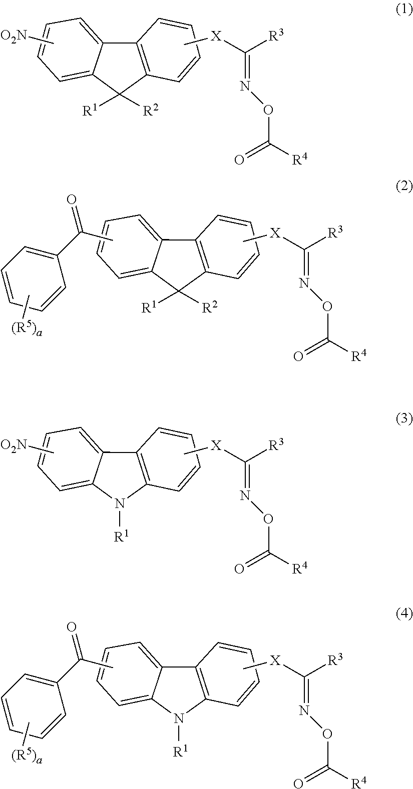

In Formula (1), R¹ and R² each independently represent an alkyl group with a carbon number of 1 to 20, an alicyclic hydrocarbon group with a carbon number of 4 to 20, an aryl group with a carbon number of 6 to 30, or an arylalkyl group with a carbon number of 7 to 30; in a case where R¹ and R² represent phenyl groups, the phenyl groups may be bonded together to form a fluorene group; R³ and R⁴ each independently represent a hydrogen atom, an alkyl group with a carbon number of 1 to 20, an aryl group with a carbon number of 6 to 30, an arylalkyl group with a carbon number of 7 to 30, or a heterocyclic group with a carbon number of 4 to 20; and X represents a direct bond or a carbonyl group.

In Formula (2), R¹, R², R³, and R⁴ have the same definitions as R¹, R², R³, and R⁴ in Formula (1), R⁵ represents —R⁶, —OR⁶, —SR⁶, —COR⁶, —CONR⁶R⁶, —NR⁶COR⁶, —OCOR⁶, —COOR⁶, —SCOR⁶, —OCSR⁶, —COSR⁶, —CSOR⁶, —CN, a halogen atom, or a hydroxyl group, R⁶ represents an alkyl group with a carbon number of 1 to 20, an aryl group with a carbon number of 6 to 30, an arylalkyl group with a carbon number of 7 to 30, or a heterocyclic group with a carbon number of 4 to 20, X represents a direct bond or a carbonyl group, and a represents an integer of 0 to 4.

In Formula (3), R¹ represents an alkyl group with a carbon number of 1 to 20, an alicyclic hydrocarbon group with a carbon number of 4 to 20, an aryl group with a carbon number of 6 to 30, or an arylalkyl group with a carbon number of 7 to 30; R³ and R⁴ each independently represent a hydrogen atom, an alkyl group with a carbon number of 1 to 20, an aryl group with a carbon number of 6 to 30, an arylalkyl group with a carbon number of 7 to 30, or a heterocyclic group with a carbon number of 4 to 20; and X represents a direct bond or a carbonyl group.

In Formula (4), R¹, R³, and R⁴ have the same definitions as R¹, R³, and R⁴ in Formula (3), R⁵ represents —R⁶, —OR⁶, —SR⁶, —COR⁶, —CONR⁶R⁶, —NR⁶COR⁶, —OCOR⁶, —COOR⁶, —SCOR^{E}, —OCSR⁶, —COSR⁶, —CSOR⁶, —CN, a halogen atom, or a hydroxyl group, R⁶ represents an alkyl group with a carbon number of 1 to 20, an aryl group with a carbon number of 6 to 30, an arylalkyl group with a carbon number of 7 to 30, or a heterocyclic group with a carbon number of 4 to 20, X represents a direct bond or a carbonyl group, and a represents an integer of 0 to 4.

In the Formulas (1) and (2), each of R¹ and R² is preferably a methyl group, an ethyl group, an n-propyl group, an i-propyl group, a cyclohexyl group, or a phenyl group. R³ is preferably a methyl group, an ethyl group, a phenyl group, a tolyl group, or a xylyl group. R⁴ is preferably an alkyl group or a phenyl group with a carbon number of 1 to 6. R⁵ is preferably a methyl group, an ethyl group, a phenyl group, a tolyl group, or a naphthyl group. X is preferably a direct bond.

In the Formulas (3) and (4), R¹ is preferably a methyl group, an ethyl group, an n-propyl group, an i-propyl group, a cyclohexyl group, or a phenyl group. R³ is preferably a methyl group, an ethyl group, a phenyl group, a tolyl group, or a xylyl group. R⁴ is preferably an alkyl group with a carbon number of 1 to 6, or a phenyl group. R⁵ is preferably a methyl group, an ethyl group, a phenyl group, a tolyl group, or a naphthyl group. X is preferably a direct bond.

Specific examples of the compounds represented by Formulas (1) and (2) include the compounds described in paragraphs 0076 to 0079 of JP2014-137466A. What are described in these documents are incorporated into the present specification.

Specific examples of the oxime compound preferably used in the aforementioned composition will be shown below. Among the following oxime compounds, the oxime compound represented by General Formula (C-13) is more preferable.

Furthermore, as the oxime compound, the compounds described in Table 1 of WO2015/036910A can also be used, and what are described in the document are incorporated into the present specification.

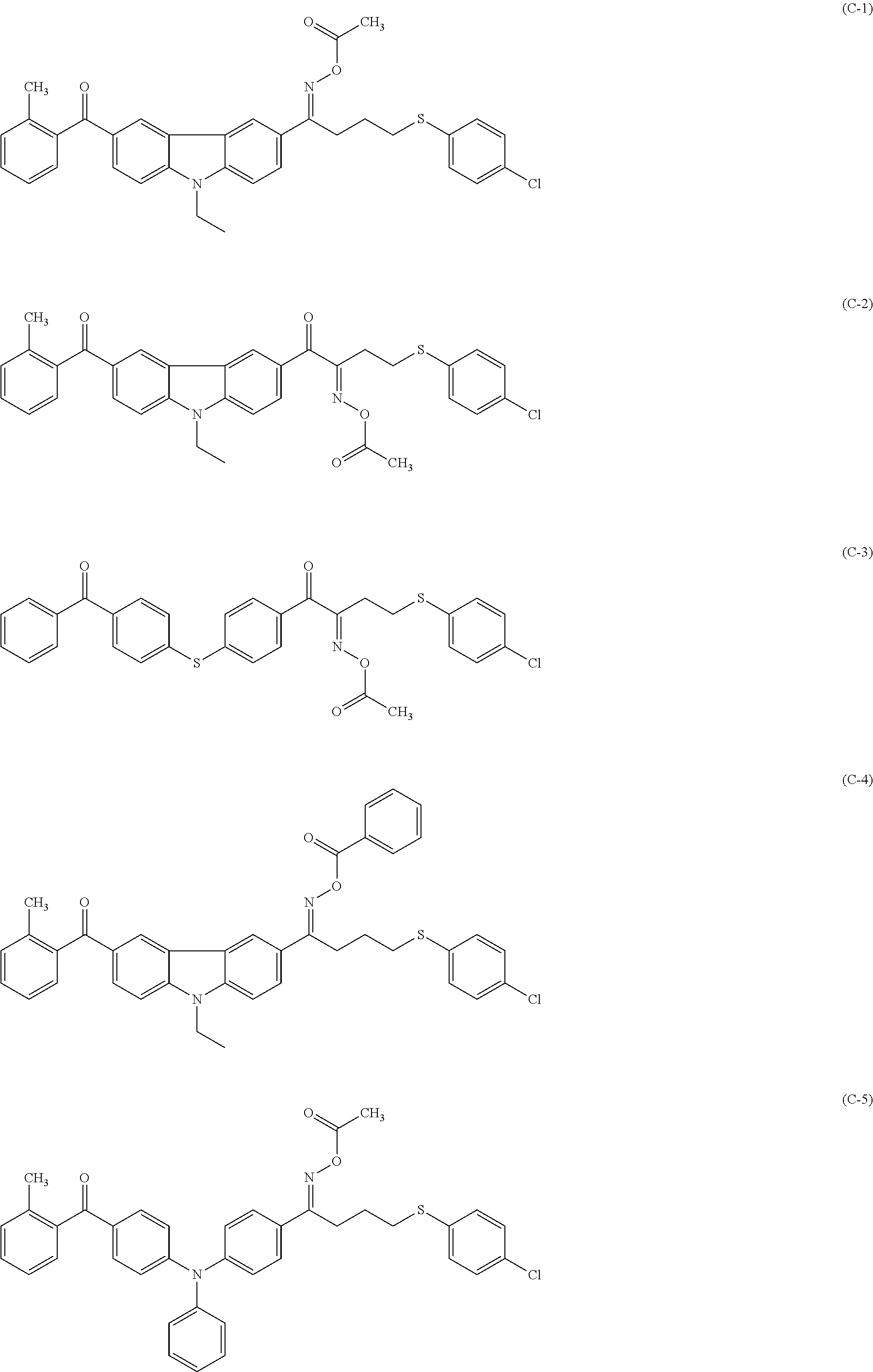 [SMILES: CCn1c2ccc(C(=O)c3ccccc3C)cc2c2cc(/C(CCCSc3ccc(Cl)cc3)=N/OC(C)=O)ccc21 ; CCn1c2ccc(C(=O)/C(CCSc3ccc(Cl)cc3)=N/OC(C)=O)cc2c2cc(C(=O)c3ccccc3C)ccc21 ; CC(=O)O/N=C(\CCSc1ccc(Cl)cc1)C(=O)c1ccc(Sc2ccc(C(=O)c3ccccc3)cc2)cc1 ; CCn1c2ccc(C(=O)c3ccccc3C)cc2c2cc(/C(CCCSc3ccc(Cl)cc3)=N/OC(=O)c3ccccc3)ccc21 ; CC(=O)O/N=C(\CCCSc1ccc(Cl)cc1)c1ccc(N(c2ccccc2)c2ccc(C(=O)c3ccccc3C)cc2)cc1]

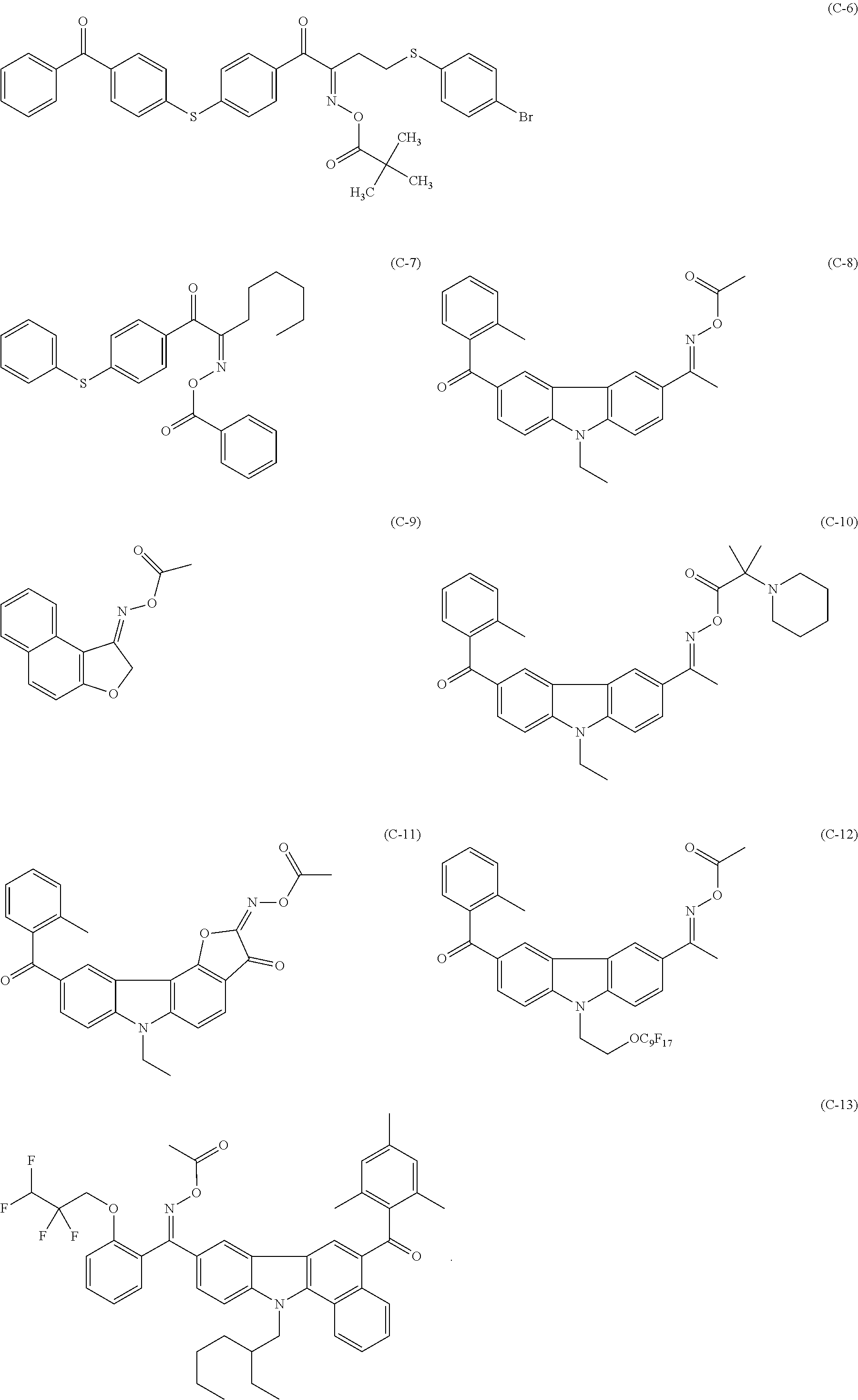

The oxime compound preferably has a maximum absorption wavelength in a wavelength range of 350 to 500 nm, more preferably has a maximum absorption wavelength in a wavelength range of 360 to 480 nm, and even more preferably has a high absorbance at wavelengths of 365 nm and 405 nm.

In view of sensitivity, the molar absorption coefficient of the oxime compound at 365 nm or 405 nm is preferably 1,000 to 300,000, more preferably 2,000 to 300,000, and even more preferably 5,000 to 200,000.

The molar absorption coefficient of a compound can be measured using known methods. For example, it is preferable to measure the molar absorption coefficient by using an ultraviolet-visible spectrophotometer (Cary-5 spectrophotometer manufactured by Varian) and ethyl acetate at a concentration of 0.01 g/L.

If necessary, two or more kinds of photopolymerization initiators may be used in combination.

As the photopolymerization initiator, it is also possible to use the compounds described in paragraph 0052 of JP2008-260927A, paragraphs 0033 to 0037 of JP2010-097210A, and paragraph 0044 of JP2015-068893A, and what are described in the paragraphs are incorporated into the present specification.

### Polymerizable Compound

The composition according to the aspect of the present invention may contain a polymerizable compound.

In the present specification, a polymerizable compound means a compound that is polymerized by the action of the aforementioned polymerization initiator, which is a component different from the aforementioned resin in the composition according to the aspect of the present invention. That is, the polymerizable compound does not have a graft chain.

The molecular weight of the polymerizable compound (weight-average molecular weight in a case where the polymerizable compound has a molecular weight distribution) is not particularly limited, but is preferably 2,000 or less.

The content of the polymerizable compound in the composition is not particularly limited. The content of the polymerizable compound with respect to the total solid content of the composition is preferably 1.0% to 25.0% by mass, more preferably 1.0% to 20.0% by mass, and even more preferably 3.0% to 15.0% by mass. One kind of polymerizable compound may be used alone, or two or more kinds of polymerizable compounds may be used in combination. In a case where two or more kinds of polymerizable compounds are used in combination, the total content thereof is preferably within the above range.

The polymerizable compound may be either a thermally polymerizable compound or a photopolymerizable compound, and is preferably a photopolymerizable compound because this compound makes it possible to form a pattern by exposure development.

In a case where the polymerizable compound is a photopolymerizable compound, it is preferable that the polymerizable compound is used in combination with the aforementioned photopolymerization initiator. In a case where the polymerizable compound is a thermally polymerizable compound, it is preferable that the polymerizable compound be used in combination with the aforementioned thermal polymerization initiator.

As the polymerizable compound, a compound (hereinafter, also called “ethylenically unsaturated group-containing compound”) containing a group containing an ethylenically unsaturated bond (hereinafter, also simply called “ethylenically unsaturated group”) is preferable.

The number of ethylenically unsaturated bonds in the ethylenically unsaturated group-containing compound is not particularly limited, but is preferably 1 or more, more preferably 2 or more, even more preferably 3 or more, and particularly preferably 5 or more. The upper limit of the number of ethylenically unsaturated bonds is, for example, 15 or less. Examples of the ethylenically unsaturated group include a vinyl group, a (meth)allyl group, a (meth)acryloyl group, and the like.

As the ethylenically unsaturated group-containing compound, for example, it is possible to use the compounds described in paragraph 0050 of JP2008-260927A and paragraph 0040 of JP2015-068893A, and what are described in the paragraphs are incorporated into the present specification.

The ethylenically unsaturated group-containing compound may be in any chemical form such as a monomer, a prepolymer, an oligomer, a mixture of these, and a multimer of these.

The ethylenically unsaturated group-containing compound is preferably a (meth)acrylate compound having 3 to 15 functional groups, and more preferably a (meth)acrylate compound having 3 to 6 functional groups.

As the ethylenically unsaturated group-containing compound, a compound that contains one or more ethylenically unsaturated groups and has a boiling point of 100° C. or higher under normal pressure is also preferable. For example, the compounds described in paragraph 0227 of JP2013-029760A and paragraph 0254 to 0257 of JP2008-292970A can be referred to, and what are described in the paragraphs are incorporated into the present specification.

As the ethylenically unsaturated group-containing compound, dipentaerythritol triacrylate (KAYARAD D-330 as a commercially available product; manufactured by Nippon Kayaku Co., Ltd.), dipentaerythritol tetraacrylate (KAYARAD D-320 as a commercially available product; manufactured by Nippon Kayaku Co., Ltd.), dipentaerythritol penta(meth)acrylate (KAYARAD D-310 as a commercially available product; manufactured by Nippon Kayaku Co., Ltd.), dipentaerythritol hexa(meth)acrylate (KAYARAD DPHA as a commercially available product; manufactured by Nippon Kayaku Co., Ltd., A-DPH-12E; manufactured by SHIN-NAKAMURA CHEMICAL CO, LTD.) A-DPH-12E; manufactured by Shin-Nakamura Kagaku Co., Ltd.), and a structure in which these, and the structure in which these (meth)acryloyl groups are mediated by an ethylene glycol residue or a propylene glycol residue (for example, SR⁴⁵⁴ and SR⁴⁹⁹ commercially available from Sartomer) are preferable. These compounds in oligomer types can also be used. Furthermore, NK ESTER A-TMMT (pentaerythritol tetraacrylate, manufactured by SHIN-NAKAMURA CHEMICAL CO, LTD.), KAYARAD RP-1040, KAYARAD DPEA-12LT, KAYARAD DPHA LT, KAYARAD RP-3060, and KAYARAD DPEA-12 (all are trade names, manufactured by Nippon Kayaku Co., Ltd.), and the like may also be used.

Preferable aspects of the ethylenically unsaturated group-containing compound will be shown below.

The ethylenically unsaturated group-containing compound may have an acid group such as a carboxylic acid group, a sulfonic acid group, or a phosphoric acid group. The ethylenically unsaturated group-containing compound containing an acid group is preferably an ester of an aliphatic polyhydroxy compound and an unsaturated carboxylic acid, more preferably an ethylenically unsaturated group-containing compound obtained by reacting an unreacted hydroxyl group of an aliphatic polyhydroxy compound with a non-aromatic carboxylic anhydride so that an acid group is added, and even more preferably an ester of the aforementioned ethylenically unsaturated group-containing compound having pentaerythritol and/or dipentaerythritol as the aliphatic polyhydroxy compound. Examples of commercially available products thereof include ARONIX TO-2349, M-305, M-510, and M-520 manufactured by TOAGOSEI CO., LTD., and the like.

The acid value of the ethylenically unsaturated group-containing compound containing an acid group is preferably 0.1 to 40 mgKOH/g, and more preferably 5 to 30 mgKOH/g. In a case where the acid value of the ethylenically unsaturated group-containing compound is 0.1 mgKOH/g or more, development and dissolution characteristics are excellent. In case where the acid value is 40 mgKOH/g or less, this is advantageous in terms of manufacturing and/or handling. Furthermore, excellent photopolymerization performance and excellent curing properties are obtained.

As the ethylenically unsaturated group-containing compound, a compound containing a caprolactone structure is also a preferable aspect.

The compound containing a caprolactone structure is not particularly limited as long as the compound contains the caprolactone structure in a molecule. Examples thereof include ε-caprolactone-modified polyfunctional (meth)acrylate obtained by esterifying a polyhydric alcohol, such as trimethylolethane, ditrimethylolethane, trimethylolpropane, ditrimethylolpropane, pentaerythritol, dipentaerythritol, tripentaerythritol, glycerin, diglycerol, or trimethylol melamine, (meth)acrylic acid, and E-caprolactone. Among these, a compound containing a caprolactone structure represented by the following Formula (Z-1) is preferable.

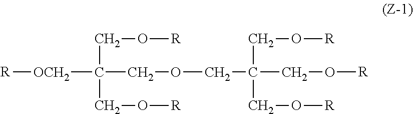

In Formula (Z-1), all six Rs are groups represented by the following Formula (Z-2), or one to five out of six Rs are groups represented by the following Formula (Z-2) and others are groups represented by the following Formula (Z-3).

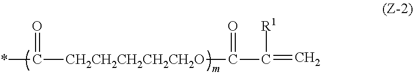

In Formula (Z-2), R¹ represents a hydrogen atom or a methyl group, m represents a number of 1 or 2, and “*” represents a bond.

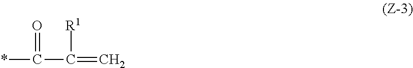

In Formula (Z-3), R¹ represents a hydrogen atom or a methyl group, and “*” represents a bond.

The ethylenically unsaturated group-containing compound containing a caprolactone structure is commercially available from Nippon Kayaku Co., Ltd., for example, as KAYARAD DPCA series. Examples thereof include DPCA-20 (compound where m in the above Formulas (Z-1) to (Z-3) is 1, the number of groups represented by Formula (Z-2) is 2, and R¹'s all represent a hydrogen atom), DPCA-30 (compound where m in the above Formulas (Z-1) to (Z-3) is 1, the number of groups represented by Formula (Z-2) is 3, and R¹'s all represent a hydrogen atom), DPCA-60 (compound where m in the above Formulas (Z-1) to (Z-3) is 1, the number of groups represented by Formula (Z-2) is 6, and R¹'s all represent a hydrogen atom), DPCA-120 (compound where m in the above Formulas (Z-1) to (Z-3) is 2, the number of groups represented by Formula (Z-2) is 6, and R¹'s all represent a hydrogen atom), and the like. Furthermore, examples of commercially available products of the ethylenically unsaturated group-containing compound containing a caprolactone structure include M-350 (trade name) (trimethylolpropane triacrylate) manufactured by TOAGOSEI CO., LTD.

As the ethylenically unsaturated group-containing compound, a compound represented by the following Formula (Z-4) or (Z-5) can also be used.

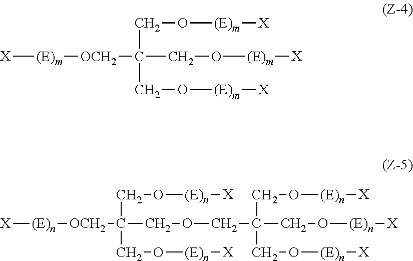

In Formulas (Z-4) and (Z-5), E represents —((CH₂)_{y}CH₂O)— or ((CH₂)_{y}CH(CH₃)O)—, y represents an integer of 0 to 10, and X represents a (meth)acryloyl group, a hydrogen atom, or a carboxylic acid group.

In Formula (Z-4), the total number of (meth)acryloyl groups is 3 or 4, m represents an integer of 0 to 10, and the total of m's is an integer of 0 to 40.

In Formula (Z-5), the total number of (meth)acryloyl groups is 5 or 6, n represents an integer of 0 to 10, and the total of n's is an integer of 0 to 60.

In Formula (Z-4), m is preferably an integer of 0 to 6, and more preferably an integer of 0 to 4.

The total of m's is preferably an integer of 2 to 40, more preferably an integer of 2 to 16, and even more preferably an integer of 4 to 8.

In Formula (Z-5), n is preferably an integer of 0 to 6, and more preferably an integer of 0 to 4.

The total of n's is preferably an integer of 3 to 60, more preferably an integer of 3 to 24, and even more preferably an integer of 6 to 12.

In addition, as for —((CH₂)_{y}CH₂O)— or ((CH₂)_{y}CH(CH₃)O)— in Formula (Z-4) or Formula (Z-5), it is preferable that the terminal on the oxygen atom side be bonded to X.

One kind of compound represented by Formula (Z-4) or Formula (Z-5) may be used alone, or two or more kinds of such compounds may be used in combination. Especially, it is preferable to employ an aspect in which all of six Xs in Formula (Z-5) represent an acryloyl group or an aspect in which a compound represented by Formula (Z-5) where all of six Xs represent an acryloyl group and a compound represented by Formula (Z-5) where at least one of six Xs represents a hydrogen atom form a mixture. This configuration can further improve developability.

The total content of the compound represented by Formula (Z-4) or Formula (Z-5) in the ethylenically unsaturated group-containing compound is preferably 20% by mass or more, and more preferably 50% by mass or more.

Among the compounds represented by Formula (Z-4) or Formula (Z-5), either or both of a pentaerythritol derivative and a dipentaerythritol derivative are more preferable.

Furthermore, the ethylenically unsaturated group-containing compound may contain a cardo skeleton. As the ethylenically unsaturated group-containing compound containing a cardo skeleton, an ethylenically unsaturated group-containing compound containing a 9,9-bisarylfluorene skeleton is preferable.

Examples of the ethylenically unsaturated group-containing compound containing a cardo skeleton include, but are not limited to, ONCOAT EX series (manufactured by NAGASE & CO., LTD.), OGSOL (manufactured by Osaka Gas Chemicals Co., Ltd.), and the like.

As the ethylenically unsaturated group-containing compound, a compound containing an isocyanuric acid skeleton as a core is also preferable. Examples of such an ethylenically unsaturated group-containing compound include NK ESTER A-9300 (manufactured by SHIN-NAKAMURA CHEMICAL CO, LTD.).

The content of ethylenically unsaturated groups in the ethylenically unsaturated group-containing compound (the content means a value obtained by dividing the number of ethylenically unsaturated groups in the ethylenically unsaturated group-containing compound by the molecular weight (g/mol) of the ethylenically unsaturated group-containing compound) is preferably 5.0 mmol/g or more. The upper limit of the content is not particularly limited, but is generally 20.0 mmol/g or less.

Furthermore, as the polymerizable compound, an oxacyclo compound is also preferable. As the oxacyclo compound, a compound having an epoxy group or an oxetanyl group is preferable, and a compound having an epoxy group (epoxy compound) is more preferable.

Specific examples of the oxacyclo compound include a monofunctional or polyfunctional glycidyl ether compound. Examples of commercially available products thereof include polyfunctional aliphatic glycidyl ether compounds such as DENACOL EX-212L, EX-214L, EX-216L, EX-321L, and EX-850L (all are manufactured by Nagase ChemteX Corporation.). Although these are low-chlorine products, EX-212, EX-214, EX-216, EX-321, EX-850, and the like that are not low-chlorine products can also be used.

Examples of the oxacyclo compound include a phenol novolac-type glycidyl ether (phenol novolac-type epoxy compound), a cresol novolac-type glycidyl ether (cresol novolac-type epoxy compound), a bisphenol A novolac-type glycidyl ether, and the like.

### Polymerization Inhibitor

The composition may contain a polymerization inhibitor.

As the polymerization inhibitor, known polymerization inhibitors can be used without particular limitation. Examples of the polymerization inhibitor include a phenol-based polymerization inhibitor (for example, p-methoxyphenol, 2,5-di-tert-butyl-4-methylphenol, 2,6-di-tert-butyl-4-methylphenol, 4,4′-thiobis(3 -methyl-6-t-butylphenol), 2,2′-methylenebis(4-methyl-6-t-butylphenol), 4-methoxynaphthol, or the like); a hydroquinone-based polymerization inhibitor (for example, hydroquinone, 2,6-di-tert-butyl hyrodroquinone, or the like); a quinone-based polymerization inhibitor (for example, benzoquinone or the like); a free radical-based polymerization inhibitor (for example, a 2,2,6,6-tetramethylpiperidine 1-oxyl free radical, a 4-hydroxy-2,2,6,6-tetramethylpiperidine 1-oxyl-free radical, or the like); a nitrobenzene-based polymerization inhibitor (for example, nitrobenzene, 4-nitrotoluene, or the like); a phenothiazine-based polymerization inhibitor (for example, phenothiazine, 2-methoxyphenothiazine, or the like); and the like.

Among these, in view of further improving the dispersion stability of the composition, a phenol-based polymerization inhibitor or a free radical-based polymerization inhibitor is preferable.

The effect of the polymerization inhibitor is marked in a case where the polymerization inhibitor is used together with a resin containing a polymerizable group.

The content of the polymerization inhibitor in the composition is not particularly limited. The content of the polymerization inhibitor with respect to the total solid content of the composition is preferably 0.0001% to 0.5% by mass, more preferably 0.0001% to 0.2% by mass, and even more preferably 0.0001% to 0.05% by mass. One kind of polymerization inhibitor may be used alone, or two or more kinds of polymerization inhibitors may be used in combination. In a case where two or more kinds of polymerization inhibitors are used in combination, the total content thereof is preferably within the above range.

The ratio of the content of the polymerization inhibitor to the content of the polymerizable compound in the composition (content of polymerization inhibitor/content of polymerizable compound (mass ratio)) is preferably more than 0.0005, more preferably 0.0006 to 0.02, and even more preferably 0.0006 to 0.005.

### Surfactant

The composition may contain a surfactant. The surfactant contributes to the improvement of the coating properties of the composition.

In a case where the composition contains a surfactant, the content of the surfactant with respect to the total solid content of the composition is preferably 0.001% to 2.0% by mass, more preferably 0.005% to 0.5% by mass, and even more preferably 0.01% to 0.1% by mass.

One kind of surfactant may be used alone, or two or more kinds of surfactants may be used in combination. In a case where two or more kinds of surfactants are used in combination, the total amount thereof is preferably within the above range.

Examples of the surfactant include a fluorine-based surfactant, a nonionic surfactant, a cationic surfactant, an anionic surfactant, a silicone-based surfactant, and the like.

For example, in a case where the composition contains a fluorine-based surfactant, the liquid properties (particularly, fluidity) of the composition are further improved. That is, in a case where a film is formed using the composition containing a fluorine-based surfactant, the interfacial tension between the surface to be coated and the coating liquid is reduced, and the wettability with respect to the surface to be coated is improved, which improves the coating properties with respect to the surface to be coated. Therefore, it is effective to use the composition containing a fluorine-based surfactant, because then a film having a uniform thickness with small thickness unevenness is more suitably formed even in a case where a thin film of about several μm is formed using a small amount of liquid.

The fluorine content in the fluorine-based surfactant is preferably 3% to 40% by mass, more preferably 5% to 30% by mass, and even more preferably 7% to 25% by mass. The fluorine-based surfactant with a fluorine content in this range is effective for achieving thickness uniformity of a coating film and/or saving liquid, and has excellent solubility in the composition.

Examples of the fluorine-based surfactant include MEGAFACE F171, MEGAFACE F172, MEGAFACE F173, MEGAFACE F176, MEGAFACE F177, MEGAFACE F141, MEGAFACE F142, MEGAFACE F143, MEGAFACE F144, MEGAFACE R^{30,} MEGAFACE F437, MEGAFACE F475, MEGAFACE F479, MEGAFACE F482, MEGAFACE F554, and MEGAFACE F780 (all are manufactured by DIC Corporation); FLUORAD FC430, FLUORAD FC431, and FLUORAD FC171 (all are manufactured by Sumitomo 3M Limited.), SURFLON S-382, SURFLON SC-101, SURFLON SC-103, SURFLON SC-104, SURFLON SC-105, SURFLON SC1068, SURFLON SC-381, SURFLON SC-383, SURFLON 5393, and SURFLON KH-40 (manufactured by AGC Inc.), PF636, PF656, PF6320, PF6520, and PF7002 (manufactured by OMNOVA Solutions Inc.), and the like.

A block polymer can also be used as the fluorine-based surfactant, and specific examples thereof include the compounds described in JP2011-089090A.

### Other Optional Components

The composition may further contain other optional components in addition to the aforementioned components. Examples thereof include a sensitizer, a co-sensitizer, a crosslinking agent (curing agent), a curing accelerator, a thermosetting accelerator, a plasticizer, a diluent, an oil sensitizing agent, a rubber component, and the like. If necessary, known additives, such as an adhesion facilitator and other aids (for example, an antifoaming agent, a flame retardant, a leveling agent, a peeling accelerator, an antioxidant, a fragrance, a surface tension adjuster, a chain transfer agent, and the like) may be further added to a substrate surface.

### Film

The composition according to the aspect of the present invention absorbs electromagnetic waves in a frequency band of 1 GHz or higher when formed into a film. The frequency band of electromagnetic waves that the film formed of the composition according to the aspect of the present invention can absorb is preferably 20 GHz or higher, and more preferably 50 GHz or higher. The upper limit of the frequency band is not particularly limited and is, for example, less than 100 GHz.

The aforementioned electromagnetic wave absorption performance is a value measured using a network analyzer for a film having a film thickness of 250 μm obtained by drying the coating film of the composition according to the aspect of the present invention. Specifically, this value corresponds to the peak frequency of the imaginary part of magnetic permeability obtained using the Nicolson-Ross model method from the S parameter at an incidence angle of 0° by the free space method.

Examples of the measurement device include a network analyzer manufactured by Agilent Technologies, Inc.

The peak frequency of the imaginary part of magnetic permeability of the film formed of the composition according to the aspect of the present invention, the peak frequency being measured by the aforementioned method, is preferably 0.2 or more, and more preferably 0.8 or more.

### Manufacturing Method of Composition

The composition according to the aspect of the present invention can be prepared by mixing together the components described above by a known mixing method (for example, a mixing method using a stirrer, a homogenizer, a high-pressure emulsifier, a wet pulverizer, a wet disperser, or the like).

In preparing the composition according to the aspect of the present invention, the components may be mixed together at once, or the components may be dissolved or dispersed one by one in a solvent and then sequentially mixed together. Furthermore, the order of adding components and working conditions at the time of mixing are not particularly limited.

In a case where the composition according to the aspect of the present invention contains components such as an alkali-soluble resin, a polymerizable compound, and a polymerization initiator, it is preferable to first manufacturing a dispersion composition containing electromagnetic wave absorbing particles and then mixing the obtained dispersion composition with other components so as to obtain a composition. The dispersion composition is preferably prepared by mixing together electromagnetic wave absorbing particles, a dispersant (preferably the aforementioned specific dispersing resin), and a solvent. Furthermore, the dispersion composition may contain a polymerization inhibitor.

### Film

The film according to an aspect of the present invention is a film formed using the composition according to the aspect of the present invention, and is preferably a cured film. Hereinafter, the manufacturing method of the cured film, the physical properties of the cured film, and the use of the cured film will be described.

### Manufacturing of Cured Film

A composition layer formed using the composition according to the aspect of the present invention is cured so that a cured film (including a patterned cured film) is obtained.

The manufacturing method of the cured film is not particularly limited, but preferably includes the following steps.

Composition layer forming step

Exposure step

Development step

Hereinafter, each step will be described.

### Composition Layer Forming Step

In the composition layer forming step, prior to exposure, the composition is applied to a substrate or the like so that a layer of the composition (composition layer) is formed. As the substrate, for example, a wiring board having an antenna portion or an inductor portion and the like can be used.

As a method for applying the composition to the substrate, various coating methods such as a slit coating method, an inkjet method, a spin coating method, a cast coating method, a roll coating method, and a screen printing method can be used. The film thickness of the composition layer is preferably 1 to 10,000 μm, more preferably 10 to 1,000 μm, and even more preferably 15 to 800 μm. The composition layer applied to the substrate is dried (prebaked), for example, using a hot plate, an oven, or the like at a temperature of 50° C. to 140° C. for 10 seconds to 6 hours.

### Exposure Step

In the exposure step, the composition layer formed in the composition layer forming step is exposed by being irradiated with an actinic ray or radiation, and the composition layer irradiated with light is cured.

Although the light irradiation method is not particularly limited, it is preferable to irradiate the composition layer with light through a photomask having a patterned opening portion.

The exposure is preferably performed by irradiation with radiation. As the radiation that can be used for exposure, an ultraviolet ray such as g-line, h-line, or i-line is particularly preferable, and a high-pressure mercury lamp is preferable as a light source. The irradiation intensity is preferably 5 to 1,500 mJ/cm², and more preferably 10 to 1,000 mJ/cm².

In a case where the composition contains a thermal polymerization initiator, the composition layer may be heated in the above exposure step. The heating temperature is not particularly limited, but is preferably 80° C. to 250° C. The heating time is not particularly limited, but is preferably 30 to 300 seconds.

In a case where the composition layer is heated in the exposure step, the heating may serve as a post-heating step which will be described later. In other words, in a case where the composition layer is heated in the exposure step, the manufacturing method of the cured film may not include a post-heating step.

### Development Step

The development step is a step of developing the exposed composition layer so as to form a cured film. By this step, the composition layer in a portion not being irradiated with light in the exposure step is eluted, and only the photo-cured portion remains. In this way, a patterned cured film is obtained.

Although the type of developer used in the development step is not particularly limited, it is desirable to use an alkali developer that does not damage the circuit or the like.

The development temperature is, for example, 20° C. to 30° C.

The development time is, for example, 20 to 90 seconds. In recent years, in order to more thoroughly remove residues, sometimes the development has been performed for 120 to 180 seconds. Furthermore, in order to further improve the residue removability, sometimes a step of shaking off the developer every 60 seconds and supplying a new developer is repeated several times.

As the alkali developer, an alkaline aqueous solution is preferable which is prepared by dissolving an alkaline compound in water at a concentration of 0.001% to 10% by mass (preferably 0.01% to 5% by mass).

Examples of the alkaline compound include sodium hydroxide, potassium hydroxide, sodium carbonate, sodium silicate, sodium metasilicate, aqueous ammonia, ethylamine, diethylamine, dimethylethanolamine, tetramethylammonium hydroxide, tetraethylammonium hydroxide, tetrapropylammonium hydroxide, tetrabutylammonium hydroxide, benzyltrimethylammonium hydroxide, choline, pyrrole, piperidine, 1,8-diazabicyclo[5.4.0]-7-undecene, and the like (among these, an organic alkali is preferable).

In a case where an alkali developer is used, generally, a rinsing treatment using water is performed after development.

### Post-Baking

It is preferable to perform a heating treatment (post-baking) after the exposure step. The post-baking is a post-development heating treatment for completion of curing. The heating temperature is preferably 240° C. or lower, and more preferably 220° C. or lower. The lower limit of the heating temperature is not particularly limited. However, considering an efficient and effective treatment, the heating temperature is preferably 50° C. or higher, and more preferably 100° C. or higher.

The post-baking can be performed continuously or in batch by using heating means such as a hot plate, a convection oven (hot air circulation-type dryer), or a high-frequency heater.

It is preferable that the aforementioned post-baking be performed in an atmosphere with a low oxygen concentration. The oxygen concentration is preferably 19% by volume or less, more preferably 15% by volume or less, even more preferably 10% by volume or less, particularly preferably 7% by volume or less, and most preferably 3% by volume or less. The lower limit of the oxygen concentration is not particularly limited, but is practically 10 ppm by volume or more.

Instead of post-baking by heating described above, ultraviolet (UV) irradiation may be performed to complete curing.

In this case, it is preferable that the aforementioned composition further contain a UV curing agent. The UV curing agent is preferably a UV curing agent that can be cured at a wavelength shorter than 365 nm, which is the exposure wavelength of the polymerization initiator added for the lithography process by ordinary i-line exposure. Examples of the UV curing agent include Ciba IRGACURE 2959 (trade name). In a case where UV irradiation is performed, it is preferable that the composition layer be a material that is cured at a wavelength of 340 nm or less. The lower limit of the wavelength is not particularly limited, but is 220 nm or more in general. The exposure amount of UV irradiation is preferably 100 to 5,000 mJ, more preferably 300 to 4,000 nil, and even more preferably 800 to 3,500 mJ. In order to more effectively cure the composition layer at a low temperature, it is preferable that this UV curing step be performed after the exposure step. As the exposure light source, it is preferable to use an ozoneless mercury lamp.

### Physical Properties of Cured Film and Use of Cured Film

The film thickness of the cured film is, for example, preferably 1 to 10,000 μm, more preferably 10 to 1,000 μm, and even more preferably 15 to 800 μm.

The frequency band of electromagnetic waves that the cured film can absorb is preferably 1 GHz or higher, more preferably 20 GHz or higher, and even more preferably 50 GHz or higher. The upper limit of the frequency band is not particularly limited and is, for example, less than 100 GHz. The frequency band of electromagnetic waves that the cured film can absorb is a value measured using a network analyzer. Specifically, the value corresponds to the peak frequency of the imaginary part of magnetic permeability obtained using the Nicolson-Ross model method from the S-parameter at an incidence angle of 0° by the free space method. Examples of the measurement device include a network analyzer manufactured by Agilent Technologies, Inc.

The cured film is suitably used as electronic components such as an antenna and an inductor installed in an electronic communication device and the like.

### EXAMPLES

Hereinafter, the present invention will be more specifically described based on examples. The materials, amounts and proportions of the materials used, details and procedures of treatments, and the like described in the following examples can be appropriately changed as long as the gist of the present invention is maintained. Therefore, the scope of the present invention is not limited to the following specific examples.

### Various Components Shown in Table 1

Hereinafter, first, various components shown in Table 1 will be described.

### Electromagnetic Wave Absorbing Particles

The electromagnetic wave absorbing particles (hereinafter, also called “particle”) P1 to P4 shown in the column of “Dispersion composition” in Table 1 will be shown below.

### Particles P1 (Hexagonal Ferrite Particles)

### Preparation of Particles P1

Water (400.0 g) kept at 35° C. was stirred. In a state where the water was being stirred, the entire quantity of a raw material aqueous solution prepared by dissolving 57.0 g of iron (III) chloride hexahydrate [FeCl₃.6H₂O], 27.8 g of strontium chloride hexahydrate [SrCl₂.6H₂O], and 10.7 g of aluminum chloride hexahydrate [AlCl₃.6H₂O] in 216.0 g of water and the entire quantity of a solution prepared by adding 113.0 g of water to 181.3 g of a 5 mol/L aqueous sodium hydroxide solution were added to the water at a flow rate of 10 mL/min each at the same addition timing, thereby obtaining a liquid 1.

Thereafter, the temperature of the liquid 1 was changed to 25° C., and then 39.8 g of a 1 mol/L aqueous sodium hydroxide solution was added thereto, thereby obtaining a liquid 2. The pH of the liquid 2 was 10.5. The pH of the liquid 2 was measured using a tabletop pH meter F-71 (trade name) manufactured by HORIBA, Ltd. (the same pH measurement method was used hereinafter).

Then, the liquid 2 was stirred for 15 minutes to terminate the reaction, thereby obtaining an aqueous solution containing a reaction product to be a precursor of hexagonal ferrite particles (that is, a precursor-containing aqueous solution).

Next, the precursor-containing aqueous solution was centrifuged three times (rotation speed: 3,000 rpm, rotation time: 10 minutes), and the obtained precipitate was collected.

Thereafter, the collected precipitate was washed with water.

Then, the precipitate washed with water was dried in an oven having an internal atmospheric temperature of 80° C. for 12 hours, thereby obtaining particles consisting of precursors (that is, precursor particles).

Next, the precursor particles were placed in a muffle furnace, the temperature condition was set in the atmosphere so that the internal temperature of the furnace was 1,060° C., and the particles were baked for 4 hours, thereby obtaining particles P1 (hexagonal ferrite particles).

### Various Measurements for Particles P1

### Crystal Structure

The crystal structure of the obtained particles P1 was confirmed by an X-ray diffraction (XRD) method. Specifically, whether the particles have a magnetoplumbite-type crystal structure and whether the particles have a single-phase or two-phase crystal structure were confirmed.

The measurement was performed using X'Pert Pro diffractometer from Malvern Panalytical Ltd as a device under the following measurement conditions.

### Measurement Conditions

X-ray source: CuKα ray

(Wavelength: 1.54 Å (0.154 nm), output: 40 mA, 45 kV)

Scan range: 20°<2θ<70°

Scan interval: 0.05°

Scan speed: 0.75°/min

As a result of the above measurement, it has been confirmed that the particles P1 have a magnetoplumbite-type crystal structure (single phase).

### Makeup

The makeup of the obtained particles P1 was confirmed by high-frequency inductively coupled plasma (ICP) emission spectroscopy. Specifically, the makeup of the particles P1 was measured as follows.

A pressure-resistant container (beaker) containing 12 mg of the particles P1 and 10 mL of a 4 mol/L aqueous hydrochloric acid solution was kept on a hot plate at a set temperature of 120° C. for 12 hours, thereby obtaining a solution. Pure water (30 mL) was added to the obtained solution, and then the solution was filtered using a 0.1 um membrane filter. For the filtrate obtained in this way, elemental analysis was performed using a high-frequency inductively coupled plasma (ICP) emission spectrophotometer (model number: ICPS-8100, Shimadzu Corporation.).

Based on the obtained results of elemental analysis, the content of each metal atom with respect to 100 at % of iron atom was determined. Then, based on the obtained content, the makeup of the particles P1 was confirmed.

The makeup of the particles P1 is as follows.

Particles P1: SrFe_{(9.58)}Al_{(2.42)}O₁₉

### Particles P2 (Hexagonal Ferrite Particles)

### Preparation of Particles P2

A solution prepared by adding 600.0 g of water to 181.5 g of a 5 mol/L aqueous sodium hydroxide solution was kept at 92° C. and stirred.

Next, in a state where the solution was being stirred, a raw material aqueous solution prepared by dissolving 57.0 g of iron (III) chloride hexahydrate [FeCl₃.6H₂O], 27.8 g of strontium chloride hexahydrate [SrCl₂.6H₂O], and 10.7 g of aluminum chloride hexahydrate [AlCl₃.6H₂O] in 216.0 g of water was added to the water at a flow rate of 3.3 mL/min, thereby obtaining a liquid 1.

Then, the temperature of the liquid 1 was changed to 25° C. The pH of the liquid 1 (liquid temperature: 25° C.) was 8.0.

Then, the liquid 1 was stirred for 15 minutes to terminate the reaction, thereby obtaining an aqueous solution containing a reaction product to be a precursor of hexagonal ferrite particles (that is, a precursor-containing aqueous solution).

Next, the precursor-containing aqueous solution was centrifuged three times (rotation speed: 3,000 rpm, rotation time: 10 minutes), and the obtained precipitate was collected.

Thereafter, the collected precipitate was washed with water.

Thereafter, the precipitate washed with water was dried in an oven having an internal atmospheric temperature of 80° C. for 12 hours. Strontium chloride in an amount of 10% by mass with respect to the particles obtained by drying was added to the particles, and the particles and the strontium chloride were thoroughly mixed together, thereby obtaining particles consisting of precursors (that is, precursor particles).

Next, the precursor particles were placed in a muffle furnace, the temperature condition was set in the atmosphere so that the internal temperature of the furnace was 1,060° C., and the particles were baked for 4 hours, thereby obtaining particles P2 (hexagonal ferrite particles).

### Various Measurements for Particles P2

The crystal structure and makeup of the particles P2 were measured by the method described in <Various measurements for particles P1> described above. The measurement results are as below.

Crystal structure: magnetoplumbite-type crystal structure (single phase)

Makeup: SrFe_{(10.44)}Al_{(1.56)}O₁₉

### Particles P3 (Hexagonal Ferrite Particles)

### Preparation of Particles P3

Particles P3 (hexagonal ferrite particles) were obtained by the same operation as that performed for obtaining the particles P1, except that a precursor-containing aqueous solution was obtained in the following manner.

Water (400.0 g) kept at 35° C. was stirred. In a state where the water was being stirred, the entire quantity of a raw material aqueous solution prepared by dissolving 57.0 g of iron (III) chloride hexahydrate [FeCl₃.6H₂O], 27.8 g of strontium chloride hexahydrate [SrCl₂.6H₂O], and 12.2 g of aluminum chloride hexahydrate [AlCl₃.6H₂O] in 215.2 g of water and the entire quantity of a solution prepared by adding 109.0 g of water to 185.7 g of a 5 mol/L aqueous sodium hydroxide solution were added to the water at a flow rate of 10 mL/min each at the same addition timing, thereby obtaining a liquid 1.

Thereafter, the temperature of the liquid 1 was changed to 25° C., and then 39.8 g of a 1 mol/L aqueous sodium hydroxide solution was added thereto, thereby obtaining a liquid 2. The pH of the liquid 2 was 10.5.

Then, the liquid 2 was stirred for 15 minutes to terminate the reaction, thereby obtaining an aqueous solution containing a reaction product to be a precursor of hexagonal ferrite particles (that is, a precursor-containing aqueous solution).

### Various Measurements for Particles P3

The crystal structure and makeup of the particles P3 were measured by the method described in <Various Measurements for Particles P1> described above. The measurement results are as below.

Crystal structure: magnetoplumbite-type crystal structure (single phase)

Makeup: SrFe_{(9.27)}Al_{(2.73)}O₁₉

### Particles P4 (Fe—Co-Based Alloy Particles)

Particles P4: iron-cobalt alloy particles (manufactured by DOWA Electronics Materials Co., Ltd., average primary particle diameter: 0.1 μm)

### Dispersant (Resin X1) Solution

The dispersant (resin X1) solution shown in the column of “Dispersion composition” in Table 1 is shown below. As the resin X1 contained in the dispersant (resin X1) solution, a synthesized resin was used.

### Synthesis of Resin X1

### Synthesis of Macromonomer X1

ε-Caprolactone (1044.2 g), δ-valerolactone (184.3 g), and 2-ethyl-1-hexanol (71.6 g) were introduced into a three-neck flask, thereby obtaining a mixture. Then, the mixture was stirred in a state where nitrogen was being introduced into the flask. Next, Disperbyk 111 (12.5 g, manufactured by BYK-Chemie GmbH., phosphoric acid resin) was added to the mixture, and the obtained mixture was heated to 90° C. After 6 hours, the disappearance of signals derived from 2-ethyl-1-hexanol in the mixture was confirmed using nuclear magnetic resonance (¹H-NMR), and then the mixture was heated to 110° C. A polymerization reaction was continued for 12 hours at 110° C. under a nitrogen stream, the disappearance of signals derived from s-caprolactone and δ-valerolactone was then confirmed by ¹H-NMR, and the molecular weight of the obtained compound was measured by the GPC method. After the molecular weight of the compound was confirmed to reach a desired value, 2,6-di-t-butyl-4-methylphenol (0.35 g) was added to the mixture containing the aforementioned compound. Thereafter, 2-methacryloyloxyethyl isocyanate (87.0 g) was added dropwise to the obtained mixture for 30 minutes. Six hours after the completion of the dropwise addition, the disappearance of signals derived from 2-methacryloyloxyethyl isocyanate (MOI) was confirmed by Then, propylene glycol monomethyl ether acetate (PGMEA) (1387.0 g) was added to the mixture, thereby obtaining a macromonomer X1 solution (2,770 g) having a concentration of 50% by mass. The weight-average molecular weight of the obtained macromonomer X1 was 6,000.

### Synthesis of Resin X1

The aforementioned macromonomer X1 solution (200.0 g), methacrylic acid (MAA, 60.0 g), benzyl methacrylate (BzMA, 40.0 g), and PGMEA (366.7 g) were introduced into a three-neck flask, thereby obtaining a mixture. The mixture was stirred in a state where nitrogen was being introduced into the flask. Then, in a state where a nitrogen stream was being introduced into the flask, the mixture was heated to 75° C. Thereafter, dodecyl mercaptan (5.85 g) and V-601 (manufactured by FUJIFILM Wako Pure Chemical Corporation, polymerization initiator, 1.48 g) were sequentially added to the mixture to initiate a polymerization reaction. The mixture was heated at 75° C. for 2 hours, and then V-601 (1.48 g) was further added to the mixture. After 2 hours, V-601 (1.48 g) was further added to the mixture. The reaction was continued for 2 more hours, and the mixture was heated to 90° C. and stirred for 3 hours. By the above operation, the polymerization reaction was terminated.

After reaction was terminated, tetrabutylammonium bromide (TBAB, 7.5 g) and p-methoxyphenol (MEHQ, 0.13 g) were added thereto in the air, and then glycidyl methacrylate (GMA, 66.1 g) was added dropwise thereto. After the dropwise addition ended, the reaction was continued in the air for 7 hours, and then the acid value was measured to confirm the termination of the reaction.

### Preparation of Dispersant (Resin X1) Solution

PGMEA was added to the obtained mixture, thereby obtaining a 30% by mass solution of resin X1 (hereinafter, also called “30% by mass PGMEA solution of the resin X1”). The obtained resin X1 had a weight-average molecular weight of 35,000 and an acid value of 50 mgKOH/mg.

### Solvent

The solvents S1 and S2 shown in the column of “Solvent” in Table 1 are as below.

S1: PGMEA (boiling point: 146° C.)

S2: Butyl acetate (boiling point: 126° C.)

### Polymerizable Compound

The polymerizable compounds M1 and M2 shown in the column of “Polymerizable compound” in Table 1 are as below.

M1: KAYARAD DPHA (manufactured by Nippon Kayaku Co., Ltd.)

M2: NK ESTER A-DPH-12E (manufactured by SHIN-NAKAMURA CHEMICAL CO, LTD.)

### Polymerization Initiator

The polymerization initiators I-1 and I-2 shown in the column of “Polymerization initiator” in Table 1 are as below.

I-1: IRGACURE OXE03 (manufactured by BASF SE)

I-2: IRGACURE OXE01 (manufactured by BASF SE)

### Resin Solution (B1) and Resin (B2

The resin solution B1 and the resin B2 shown in “Resin solution (B1) or resin (B2)” in Table 1 are as below.

B1: “RD-F8” (manufactured by NIPPON SHOKUBAI CO., LTD., solid content 40% by mass, solvent: propylene glycol monomethyl ether (PGME: boiling point 121° C.))

B2: “EPICLON N-695” (cresol novolac-type polyfunctional epoxy resin, DIC Corporation)

### Polymerization Inhibitor

The polymerization inhibitor shown in “Polymerization inhibitor” in Table 1 is p-methoxyphenol.

### Surfactant

The surfactant shown in “Surfactant” in Table 1 is the following surfactant (S) (weight-average molecular weight (Mw): 15,311).

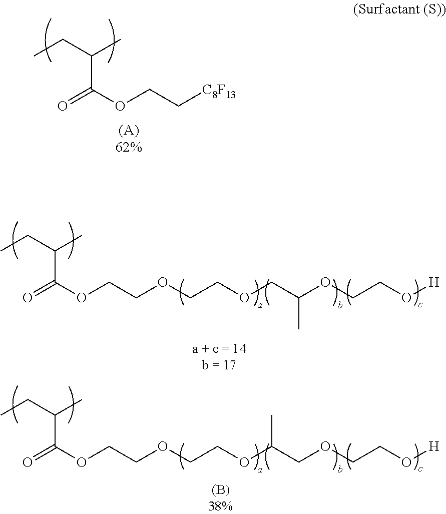

Here, the amounts of repeating units represented by (A) and (B) in the formula are 62 mol % and 38 mol %, respectively. In the repeating unit represented by Formula (B), a, b, and c satisfy the relations of a+c=14 and b=17, respectively.

### Example 1

### Preparation of Dispersion Composition

Components were blended so that the following compositional ratio (mass ratio) was obtained, mixed and stirred together by using a stirrer, and the obtained mixture was dispersed using NPM-Pilot manufactured by Shinmaru Enterprises Corporation. under the following dispersion conditions, thereby obtaining a dispersion composition.

Particles P1: 83 parts by mass

Dispersant (resin X1) solution (30% by mass PGMEA solution of resin X1): 17 parts by mass

The dispersion conditions are as follows.

Bead diameter: φ0.05 mm, (zirconia beads manufactured by NIKKATO CORPORATION, YTZ)

Bead filling rate: 65% by volume

Circumferential speed of mill: 10 m/sec

Treatment liquid temperature: 19° C. to 21° C.

### Preparation of Composition 1

The aforementioned dispersion composition was mixed with the following other components, thereby obtaining a composition 1.

The aforementioned dispersion composition: 85 parts by mass.

Resin solution (B1: “RD-F8” (manufactured by NIPPON SHOKUBAI CO., LTD., solid content 40% by mass, solvent: propylene glycol monomethyl ether (PGME: boiling point 121° C.)): 5.0 parts by mass

Solvent (S1: PGMEA): 5.3 parts by mass

Polymerizable compound (M1: KAYARAD DPHA, manufactured by Nippon Kayaku Co., Ltd.): 2.9 parts by mass

Polymerization initiator (I-1: IRGACURE OXE03, manufactured by BASF SE): 1.8 parts by mass

Polymerization inhibitor (p-methoxyphenol): 0.01 parts by mass

Surfactant (surfactant (S) described above): 0.02 parts by mass

### Example 2

A composition 2 was prepared by the same method as in Example 1, except that the particles P2 were used instead of the particles P1.

### Example 3

A composition 3 was prepared by the same method as in Example 1, except that the particles P3 were used instead of the particles P1.

### Example 4

A composition 4 was prepared by the same method as in Example 1, except that the particles P4 were used instead of the particles P1.

### Example 5

A composition 5 was prepared by the same method as in Example 1, except that the amount of the particles P1 added was changed to 88 parts by mass, and the amount of the dispersant X solution added was changed to 12 parts by mass.

### Example 6

A composition 6 was prepared by the same method as in Example 1, except that the amount of the particles P1 added was changed to 79 parts by mass, and the amount of the dispersant X solution added was changed to 21 parts by mass.

### Example 7

A composition 7 was prepared by the same method as in Example 1, except that the amount of the solvent Si added was 2.65 parts by mass, and the amount of the solvent S2 added was 2.65 parts by mass.

### Example 8

A composition 8 was prepared by the same method as in Example 1, except that the amount of the polymerizable compound M1 added was 1.45 parts by mass, and the amount of the polymerizable compound M2 added was 1.45 parts by mass.

### Example 9

A composition 9 was prepared by the same method as in Example 1, except that the amount of the polymerization initiator I-1 was 0.9 parts by mass, and the amount of the polymerization initiator I-2 added was 0.9 parts by mass.

### Example 10

The aforementioned dispersion composition was mixed with other components shown below, thereby obtaining a composition 10.

Dispersion composition: 85 parts by mass

Resin (B2: Epoxy resin, EPICLON N-695, manufactured by DIC Corporation): 6.5 parts by mass

Solvent (S1: PGMEA): 8.5 parts by mass

Surfactant (surfactant (S) described above): 0.02 parts by mass

### Evaluation

Each of the obtained compositions was evaluated as below.

### Electromagnetic Wave Absorption Characteristics

A peeling film [trade name: PANAPEEL (registered trademark P75A, PANAC Corporation.)] was coated with the obtained composition by using an applicator, thereby forming a coating film. Then, the formed coating film was dried in an oven having an internal atmospheric temperature of 80° C. for 2 hours, thereby obtaining a laminate including a peeling film and an electromagnetic wave absorbing layer formed thereon. Thereafter, the peeling film was removed from the obtained laminate, thereby obtaining an electromagnetic wave absorbing sheet (sheet thickness: 250 μm) of examples.

For the prepared electromagnetic wave absorbing sheet, the S-parameter at an incidence angle of 0° was measured by the free space method. From the measured S-parameter, the magnetic permeability [μ″ peak frequency (unit: GHz) and μ″ peak value] of the imaginary part was calculated using the Nicolson-Ross model method. As a device, a network analyzer from Agilent Technologies, Inc. was used. The evaluation standard is as follows.

### Evaluation Standard

(μ″ Peak Frequency)

“A”: 50 GHz or higher and less than 100 GHz

“B”: 1 GHz or higher and less than 50 GHz

“C”: Less than 1 GHz

(μ″ Peak Value)

“A”: 0.8 or more

“B”: 0.2 or more and less than 0.8

“C”: less than 0.2

### Dispersion Stability

Each of the compositions of examples was stored at 23° C. for 30 days. Then, the viscosity of each composition was measured before and after storage by using an E-type viscometer (manufactured by TOKI SANGYO CO., LTD., trade name “R⁸⁵ type viscometer”) under the conditions of a rotation speed of 10 rpm and 23° C. From the measured viscosity, a T value (%) represented by the following Formula (X) was calculated, and the dispersion stability was evaluated based on the following evaluation standard. The evaluation standard is as follows.

T (%)={(viscosity of composition after storage−viscosity of composition before storage)/Viscosity of composition before storage}×100 Formula (X):

### Evaluation Standard “A”: T value is 3% or less in an absolute value. “B”: T value is more than 3% and 10% or less in an absolute value. “C”: T value is more than 10% in an absolute value.

The results are shown in Tables 1 and 2.

In Table 1, “Content (% by mass) of dispersant (resin X)” in the column of “Note” shows the content (% by mass) of the dispersant (resin X) with respect to the total mass of the composition.

In Table 1, “Content (% by mass) of solvent” in the column of “Note” shows the content (% by mass) of the solvent with respect to the total mass of the composition.

In Table 1, “Content (% by mass) of electromagnetic wave absorbing particles” in the column of “Note” shows the content (% by mass) of the electromagnetic wave absorbing particles with respect to the total mass of the composition.

In Table 2, “A” in the column of “Whether or not composition exhibits electromagnetic wave absorption performance in frequency band of 1 GHz or higher when formed into film” means that the composition exhibits electromagnetic wave absorption performance in a frequency band of 1 GHz or higher when formed into a film, and “B” in the same column means that the composition does not exhibit electromagnetic wave absorption performance in a frequency band of 1 GHz or higher when formed into a film.

TABLE 1

| | | Makeup of composition | | | | | | | |
|---|---|---|---|---|---|---|---|---|---|
| | | | | | | | | Polymerizable | |
| | | Dispersion composition | | | | | | compound | |
| | | Makeup | | | | | | (ethylenically | |
| | | Electromagnetic | | Content of | | | | unsaturated | |
| | | wave absorbing | | dispersant | | | | group-containing | |
| | | particles | | (resin X1) | | Solvent | | compound) | |
| | | | Content | solution | Content | | Content | | Content |
| | Composition | | (parts by | (parts by | (parts by | | (parts by | | (parts by |
| | No. | Type | mass) | mass) | mass) | Type | mass) | Type | mass) |
| Example | Composition | P1 | 83 | 17 | 85 | S1 | 5.3 | M1 | 2.9 |
| 1 | 1 | | | | | | | | |
| Example | Composition | P2 | 83 | 17 | 85 | S1 | 5.3 | M1 | 2.9 |
| 2 | 2 | | | | | | | | |
| Example | Composition | P3 | 83 | 17 | 85 | S1 | 5.3 | M1 | 2.9 |
| 3 | 3 | | | | | | | | |
| Example | Composition | P4 | 83 | 17 | 85 | S1 | 5.3 | M1 | 2.9 |
| 4 | 4 | | | | | | | | |
| Example | Composition | P1 | 88 | 12 | 85 | S1 | 5.3 | M1 | 2.9 |
| 5 | 5 | | | | | | | | |
| Example | Composition | P1 | 79 | 21 | 85 | S1 | 5.3 | M1 | 2.9 |
| 6 | 6 | | | | | | | | |
| Example | Composition | P1 | 83 | 17 | 85 | S1 | 2.65 | M1 | 2.9 |
| 7 | 7 | | | | | S2 | 2.65 | | |
| Example | Composition | P1 | 83 | 17 | 85 | S1 | 5.3 | M1 | 1.45 |
| 8 | 8 | | | | | | | M2 | 1.45 |
| Example | Composition | P1 | 83 | 17 | 85 | S1 | 5.3 | M1 | 2.9 |
| 9 | 9 | | | | | | | | |
| Example | Composition | P1 | 83 | 17 | 85 | S1 | 8.5 | — | — |
| 10 | 10 | | | | | | | | |
| | Makeup of composition | | | | | | Note | | |
| | Polymerization | | Resin solution | | | | Content of | | |
| | initiator | | (B1) or resin (B2) | | | | electromagnetic | Content of | Content of |
| | | Content | | Content | Polymerization | Surfactant | wave absorbing | dispersant | solvent |
| | | (parts by | | (parts by | inhibitor | (parts by | particles | (resin X1) | (% by |
| | Type | mass) | Type | mass) | (parts by mass) | mass) | (% by mass) | (% by mass) | mass) |
| Example | I-1 | 1.8 | B1 | 5.0 | 0.01 | 0.02 | 70.6 | 4.3 | 18.4 |
| 1 | | | | | | | | | |
| Example | I-1 | 1.8 | B1 | 5.0 | 0.01 | 0.02 | 70.6 | 4.3 | 18.4 |
| 2 | | | | | | | | | |
| Example | I-1 | 1.8 | B1 | 5.0 | 0.01 | 0.02 | 70.6 | 4.3 | 18.4 |
| 3 | | | | | | | | | |
| Example | I-1 | 1.8 | B1 | 5.0 | 0.01 | 0.02 | 70.6 | 4.3 | 18.4 |
| 4 | | | | | | | | | |
| Example | I-1 | 1.8 | B1 | 5.0 | 0.01 | 0.02 | 74.8 | 3.1 | 15.4 |
| 5 | | | | | | | | | |
| Example | I-1 | 1.8 | B1 | 5.0 | 0.01 | 0.02 | 67.2 | 5.4 | 20.8 |
| 6 | | | | | | | | | |
| Example | I-1 | 1.8 | B1 | 5.0 | 0.01 | 0.02 | 70.6 | 4.3 | 18.4 |
| 7 | | | | | | | | | |
| Example | I-1 | 1.8 | B1 | 5.0 | 0.01 | 0.02 | 70.6 | 4.3 | 18.4 |
| 8 | | | | | | | | | |
| Example | I-1 | 0.9 | B1 | 5.0 | 0.01 | 0.02 | 70.6 | 4.3 | 18.4 |
| 9 | I-2 | 0.9 | | | | | | | |
| Example | — | — | B2 | 6.5 | — | 0.02 | 70.6 | 4.3 | 18.6 |
| 10 | | | | | | | | | |

TABLE 2

| | | Evaluation result | | | |
|---|---|---|---|---|---|
| | | Magnetic | | | |
| | | permeability (imaginary part) | | | |
| | | | | Note | |
| | | | | Whether or not | |
| | | | | composition | |
| | | | | exhibits | |
| | | | | electromagnetic | |
| | | | | wave absorption | |
| | | μ″ | | performance in | |
| | | Peak | | frequency band | |
| | | fre- | Peak | of 1 GHz or | Dis- |
| | Composition | quency | value | higher when | persion |
| | No. | (GHz) | of μ″ | formed into film | stability |
| Example 1 | Composition 1 | A | A | A | A |
| Example 2 | Composition 2 | A | B | A | A |
| Example 3 | Composition 3 | A | A | A | A |
| Example 4 | Composition 4 | B | A | A | A |
| Example 5 | Composition 5 | A | A | A | A |
| Example 6 | Composition 6 | A | B | A | A |
| Example 7 | Composition 7 | A | A | A | A |
| Example 8 | Composition 8 | A | A | A | A |
| Example 9 | Composition 9 | A | A | A | A |
| Example 10 | Composition 10 | A | A | A | A |

From the results shown in Tables 1 and 2, it has been confirmed that all the compositions 1 to 10 have excellent dispersion stability and absorb electromagnetic waves in a frequency band of 1 GHz or higher when formed into a film. It has been confirmed that the films formed of the compositions 1 to 10 (compositions of examples) have excellent electromagnetic wave absorption performance (the peak value (μ″) of the magnetic permeability of the imaginary part is observed at a high frequency and/or the peak value (μ″) is large).

Furthermore, by the comparison of Examples 1 to 4, it has been confirmed that in a case where the electromagnetic wave absorbing particles are magnetoplumbite-type hexagonal ferrite particles represented by Formula (F1) described above, the peak value (μ″) of the magnetic permeability of the imaginary part is observed at a high frequency. Furthermore, it has been confirmed that in a case where 2.0≤x≤6.0 is satisfied in Formula (F1), the peak value (μ″) of the magnetic permeability of the imaginary part further increases.

In addition, by the comparison between Example 1 and Example 6, it has been confirmed that in a case where the mass ratio of the content of the dispersant to the content of the electromagnetic wave absorbing particles in the composition (content of dispersant/content of electromagnetic wave absorbing particles) is 0.065 or less, the peak value (μ″) of the magnetic permeability of the imaginary part further increases.

### Example 11 (Evaluation on Patterning Properties)

By using an applicator, an 8-inch silicon wafer (substrate) was coated with each of the compositions of Examples 1 to 9, thereby forming a coating film At this time, the gradations of the applicator were adjusted so that the film thickness of the composition layer formed by a heating treatment (pre-baking) performed for 120 seconds by using a hot plate at 100° C. followed by drying was 250 μm. The dried composition layer was exposed using an i-line stepper through a line-and-space pattern mask having a pattern width of 200 μμm. The cured film obtained after exposure was subjected to puddle development at 23° C. for 60 seconds by using a 0.3% by mass aqueous solution of tetramethylammonium hydroxide, rinsed by spin shower, and then further washed with pure, thereby obtaining a cured film having a pattern.

From the above results, it has been confirmed that the compositions obtained in Examples 1 to 9 have excellent patterning properties.

What is claimed is:

1. A composition comprising:
electromagnetic wave absorbing particles;
a dispersant; and
a solvent,
wherein the composition absorbs electromagnetic waves in a frequency band of 1 GHz or higher when formed into a film.

2. The composition according to claim 1,
wherein the particles include magnetoplumbite-type hexagonal ferrite particles represented by the following Formula (1),
AFe₍₁₂₋ₓ₎AlₓO₁₉ Formula (1)
in Formula (1), A represents at least one kind of metal element selected from the group consisting of Sr, Ba, Ca, and Pb, and x satisfies 1.5≤x≤8.0.

3. The composition according to claim 1,
wherein the particles include Fe—Co-based alloy particles.

4. The composition according to claim 1,
wherein the composition absorbs electromagnetic waves in a frequency band of 1 GHz or higher and less than 100 GHz when formed into a film.

5. The composition according to claim 1,
wherein the dispersant has a molecular weight of 50,000 or less.

6. The composition according to claim 1,
wherein the dispersant is a resin having a graft chain.

7. The composition according to claim 1,
wherein a content of the particles is 60.0% to 95.0% by mass with respect to a total mass of the composition.

8. The composition according to claim 1,
wherein a content of the dispersant is 1.0% to 10.0% by mass with respect to a total mass of the composition.

9. The composition according to claim 1,
wherein a content of the solvent is 10.0% to 30.0% by mass with respect to a total mass of the composition.

10. The composition according to claim 1,
wherein a boiling point of the solvent is 110° C. to 170° C.

11. The composition according to claim 1, further comprising:
a thermally polymerizable compound.

12. The composition according to claim 1, further comprising:
a photopolymerizable compound.

13. The composition according to claim 12, further comprising:
a photopolymerization initiator.

14. A film formed of the composition according to claim 1.

15. A cured film formed by curing the composition according to claim 11.

16. A manufacturing method of a cured film, comprising:
a step of forming a composition layer on a substrate by using the composition according to claim 13;
a step of exposing the composition layer in a patterned manner; and
a step of developing the exposed composition layer by using a developer.

17. An electronic component comprising:
the cured film according to claim 15.

18. The composition according to claim 2,
wherein the composition absorbs electromagnetic waves in a frequency band of 1 GHz or higher and less than 100 GHz when formed into a film.

19. The composition according to claim 2,
wherein the dispersant has a molecular weight of 50,000 or less.

20. The composition according to claim 2,
wherein the dispersant is a resin having a graft chain.
